(19) United States
(12) Patent Application Publication
(10) Pub. No.: US 2026/0153925 A1
(43) Pub. Date: Jun. 4, 2026

(54) METHOD AND APPARATUS FOR ACQUIRING GAZE POINT, ELECTRONIC DEVICE, AND STORAGE MEDIUM

(71) Applicant: BOE Technology Group Co., Ltd., Beijing (CN)

(72) Inventors: Xingchen LIU, Beijing (CN); Honghong JIA, Beijing (CN); Zhanfu AN, Beijing (CN)

(21) Appl. No.: 18/291,560

(22) PCT Filed: Nov. 30, 2022
(86) PCT No.: PCT/CN2022/135683

§ 371 Date: Jan. 23, 2024

(51) Int. Cl. G06F 3/01; H04N 23/60

(52) U.S. Cl. CPC G06F 3/013; H04N 23/60

(57) ABSTRACT

A method and apparatus for acquiring a gaze point, an electronic device, and a storage medium are provided. The method includes: acquiring an original image from a camera; acquiring, from the original image, a left-eye image, a right-eye image, a face image, and a head-camera rotation matrix; acquiring, from the left-eye image, the right-eye image, the face image, and the head-camera rotation matrix, a gaze vector of a left eye and a right eye in a camera coordinate system; and acquiring, from the gaze vector, physical parameters of a display and an extrinsic matrix of the camera, a gaze point of a user on the display. With the present disclosure, there is no need for expensive image devices, thereby reducing the hardware cost and the complexity. Use of grayscale images to acquire the gaze vector can reduce the amount of data processing and improve the processing speed. Acquiring the gaze point after the gaze vector can be applied to different displays, which expands applicable scenes of the present disclosure.

### CROSS-REFERENCE TO RELATED APPLICATIONS

This disclosure is the U.S. national phase of PCT Application No. PCT/CN2022/135683 filed on Nov. 30, 2022, the disclosure of which is incorporated herein by reference in its entirety.

### TECHNICAL FIELD

The present disclosure relates to the field of data processing technology, and in particular to a method and apparatus for acquiring a gaze point, an electronic device, and a storage medium.

### BACKGROUND

Eye tracking is a technique for measuring a gaze point of human eyes and a degree of movement thereof relative to a human head. By tracking a gaze point of a user, it is possible to determine where and for how long the user is looking at, thereby determining what the user is watching.

In the related art, model-based methods are usually used for eye tracking. For example, a 3D general eye model is preset, and then eye parameters of an individual are calculated from infrared reflections and RGB images and substituted into a tracking model, so as to obtain an eye-gaze position.

However, in the related art, the addition of devices such as infrared cameras or head-mounted glasses increases the complexity and hardware cost.

### SUMMARY

In order to address deficiencies in the related art, the present disclosure provides a method and apparatus for acquiring a gaze point, an electronic device, and a storage medium.

According to a first aspect of embodiments of the present disclosure, there is provided a method of acquiring a gaze point, including:
acquiring an original image of a user from a camera;
acquiring a left-eye image of a left eye of the user, a right-eye image of a right eye of the user, a face image of a face of the user, and a head-camera rotation matrix from the original image, where the head-camera rotation matrix represents a rotation of a head of the user relative to the camera;
acquiring a gaze vector of the left eye and the right eye in a camera coordinate system from the left-eye image, the right-eye image, the face image, and the head-camera rotation matrix; and
acquiring a gaze point of the user on a display from the gaze vector, physical parameters of the display and an extrinsic matrix of the camera, where the extrinsic matrix of the camera represents a transformation between a display coordinate system and the camera coordinate system.

Optionally, acquiring the left-eye image, the right-eye image, the face image, and the head-camera rotation matrix from the original image, includes:
acquiring an intrinsic matrix of the camera and acquiring head pose data from the original image; and
acquiring the left-eye image, the right-eye image, and the face image, respectively, from the original image, the intrinsic matrix, and the head pose data, where the left-eye image is a front-view image centered at a center of the left eye, the right-eye image is a front-view image centered at a center of the right eye, and the face image is a front-view image centered at a center of the face.

Optionally, the method further includes:
obtaining a left-eye grayscale image and a right-eye grayscale image from the left-eye image and the right-eye image, respectively.

Optionally, acquiring the head pose data, includes:
inputting the original image into a preset keypoint detection model to obtain 2D keypoint coordinates in the camera coordinate system; and
inputting preset 3D keypoint coordinates in a head coordinate system and the 2D keypoint coordinates into a preset perspective projection model, to acquire, from the preset perspective projection model, a rotation matrix and a displacement matrix of the head relative to the camera as the head pose data.

Optionally, the preset keypoint detection model is configured to detect a preset number of keypoints of the face of the user from the original image, where the preset number is more than 106.

Optionally, acquiring the left-eye image, the right-eye image, and the face image, respectively, from the original image, the intrinsic matrix, and the head pose data, includes:
acquiring, from the head pose data, a face transformation matrix, a left-eye transformation matrix, and a right-eye transformation matrix; and
acquiring the left-eye image from the original image and the left-eye transformation matrix, acquiring the right-eye image from the original image and the right-eye transformation matrix, and acquiring the face image from the original image and the face transformation matrix.

Optionally, acquiring, from the head pose data, the face transformation matrix, includes:
adjusting an origin of a Z-axis of the camera coordinate system to be an origin of a head coordinate system such that the camera directly faces a center point of the face;
adjusting an X-axis of the camera coordinate system to be parallel to an X-axis of the head coordinate system such that the head remains horizontal in the camera coordinate system to obtain a Y-axis of the camera coordinate system;
acquiring the X-axis of the camera coordinate system from the Z-axis and the Y-axis of the camera coordinate system to obtain a face rotation matrix;
obtaining an initial face transformation matrix from the face rotation matrix and a preset scaling matrix; and
acquiring, from the intrinsic matrix, a target camera matrix and the initial face transformation matrix, the face transformation matrix of the target camera matrix with respect to an original camera matrix.

Optionally, acquiring, from the head pose data, the left-eye transformation matrix, includes:
adjusting an origin of a Z-axis of the camera coordinate system to be an origin of a left-eye coordinate system such that the camera directly faces a center point of the left eye;
adjusting an X-axis of the camera coordinate system to be parallel to an X-axis of the left-eye coordinate system such that the left eye remains horizontal in the camera coordinate system to obtain a Y-axis of the camera coordinate system;
acquiring the X-axis of the camera coordinate system from the Z-axis and the Y-axis of the camera coordinate system to obtain a left-eye rotation matrix;
obtaining an initial left-eye transformation matrix from the left-eye rotation matrix and a preset scaling matrix; and
acquiring, from the intrinsic matrix, a target camera matrix and the initial left-eye transformation matrix, the left-eye transformation matrix of the target camera matrix with respect to an original camera matrix.

Optionally, acquiring, from the head pose data, the right-eye transformation matrix, includes:
adjusting an origin of a Z-axis of the camera coordinate system to be an origin of a right-eye coordinate system such that the camera directly faces a center point of the right eye;
adjusting an X-axis of the camera coordinate system to be parallel to an X-axis of the right-eye coordinate system such that the right eye remains horizontal in the camera coordinate system to obtain a Y-axis of the camera coordinate system;
acquiring the X-axis of the camera coordinate system from the Z-axis and the Y-axis of the camera coordinate system to obtain a right-eye rotation matrix;
obtaining an initial right-eye transformation matrix from the right-eye rotation matrix and a preset scaling matrix; and
acquiring, from the intrinsic matrix, a target camera matrix and the initial right-eye transformation matrix, the right-eye transformation matrix of the target camera matrix with respect to an original camera matrix.

Optionally, acquiring the gaze vector of the left eye and the right eye in the camera coordinate system from the left-eye image, the right-eye image, the face image, and the head-camera rotation matrix, includes:
acquiring a feature for guidance from the face image and the head-camera rotation matrix;
acquiring a left-eye feature from the left-eye grayscale image and a right-eye feature from the right-eye grayscale image;
correcting the left-eye feature and the right-eye feature with the feature for guidance to obtain a corrected feature; and
splicing the feature for guidance and the corrected feature and performing fully connected processing on the spliced feature to obtain a yaw angle and a pitch angle of the head in the camera coordinate system as the gaze vector.

Optionally, acquiring the feature for guidance from the face image and the head-camera rotation matrix, includes:
extracting a facial feature from the face image;
performing fully connected processing on the head-camera rotation matrix to obtain a head-camera feature; and
splicing the facial feature and the head-camera feature to obtain the feature for guidance.

Optionally, acquiring the left-eye feature from the left-eye grayscale image and the right-eye feature from the right-eye grayscale image, includes:
acquiring a preset feature extraction network model, where the feature extraction network model is a ResNet-18 model; and
inputting the left-eye grayscale image and the right-eye grayscale image into the feature extraction network model, respectively, to obtain the left-eye feature from the left-eye grayscale image and the right-eye feature from the right-eye grayscale image.

Optionally, correcting the left-eye feature and the right-eye feature with the feature for guidance to obtain the corrected feature, includes:
correcting the left-eye feature and the right-eye feature with the feature for guidance to obtain a corrected left-eye feature and a corrected right-eye feature, respectively;
splicing the corrected left-eye feature and the corrected right-eye feature to obtain the spliced feature;
performing weight adjustment processing on the spliced feature to obtain an adjusted feature; and
correcting the adjusted feature with the feature for guidance to obtain the corrected feature.

Optionally, correcting the left-eye feature and the right-eye feature with the feature for guidance to obtain the corrected left-eye feature and the corrected right-eye feature, respectively, includes:
acquiring a preset AdaGN module having the feature for guidance as input data;
inputting the feature for guidance into the preset AdaGN module to adjust a parameter value of the AdaGN module and obtain a target AdaGN module; and
correcting the left-eye feature and the right-eye feature with the target AdaGN module to obtain the corrected left-eye feature and the corrected right-eye feature, respectively.

Optionally, acquiring the gaze vector of the left eye and the right eye in the camera coordinate system from the left-eye image, the right-eye image, the face image, and the head-camera rotation matrix, includes:
inputting the left-eye grayscale image, the right-eye grayscale image, the face image, and the head-camera rotation matrix into a preset gaze tracking model to obtain the gaze vector in the camera coordinate system from the preset gaze tracking model.

Optionally, the preset gaze tracking model is trained by operations including:
acquiring a preset sample set, where the preset sample set includes a pre-collected training sample set, and each sample in the preset sample set includes a calibrated gaze vector;
inputting each sample in the preset sample set into an initial gaze tracking model to obtain an estimated gaze vector from the initial gaze tracking model;
determining a value of a loss function from the estimated gaze vector and the calibrated gaze vector of each sample; and
in response to a difference between two adjacent values of the loss function being greater than a preset difference threshold, returning to the operation of inputting each sample in the preset sample set into the initial gaze tracking model until the difference is less than or equal to the preset difference threshold, to obtain the preset gaze tracking model.

Optionally, determining the value of the loss function from the estimated gaze vector and the calibrated gaze vector of each sample, includes:
acquiring a similarity between the estimated gaze vector and the calibrated gaze vector of each sample; and
determining a difference between a constant value and the similarity as the value of the loss function.

Optionally, each sample in the preset sample set is acquired by:
randomly displaying a preset marker on the display; and
in response to detecting that the preset marker is triggered, controlling the camera to capture a sample image involving the face of the user, where the sample image has a calibrated gaze vector matched with a position of the preset marker.

Optionally, randomly displaying the preset marker on the display, includes: dividing a display area of the display into n*n sub-display areas; and
randomly displaying the preset marker on the display in each of the sub-display areas.

Optionally, randomly displaying the preset marker on the display in each of the sub-display areas, includes:
acquiring a display duration that the preset marker is displayed in the sub-display area during display of the preset marker; and
in response to the preset marker being triggered or the display duration being equal to a preset duration and the preset marker being not triggered, stopping displaying a current preset marker and displaying a next preset marker.

Optionally, the preset marker contains a preset content, and detecting that the preset marker is triggered, includes:
receiving a trigger mode signal for a triggered position; and
in response to the trigger mode signal being matched with the preset content, determining that the preset marker is detected to be triggered.

Optionally, the preset content includes a first preset content and a second preset content, the trigger mode signal includes a first trigger mode and a second trigger mode, the first trigger mode is matched with the first preset content, and the second trigger mode is matched with the second preset content.

Optionally, the method further includes:
acquiring a user calibration vector corresponding to the user in the original image; and
calibrating the gaze vector with the user calibration vector to obtain an updated gaze vector.

Optionally, acquiring the user calibration vector corresponding to the user in the original image, includes:
displaying a preset marker on the display;
in response to detecting that the preset marker is triggered, acquiring a ground-truth vector corresponding to the preset marker, where the ground-truth vector is related to coordinate data of the preset marker and a distance between the camera and the display; and
determining a difference between the ground-truth vector and the gaze vector as the user calibration vector.

Optionally, displaying the preset marker on the display, includes:
sequentially displaying the preset marker at a plurality of designated positions of the display;
stopping displaying the preset marker in response to the preset marker being triggered or a display duration of the preset marker being equal to a preset duration; and
displaying the preset marker at a next designated position randomly selected until the preset marker is displayed once at each of the designate positions.

Optionally, acquiring the gaze point of the user on the display from the gaze vector, the physical parameters of the display and the extrinsic matrix of the camera, includes:
determining coordinate data of the display in the camera coordinate system based on the extrinsic matrix of the camera and the physical parameters of the display; and
acquiring, from the gaze vector, coordinates of a center point of the face, and the coordinate data, an intersection point of the gaze vector with the display as the gaze point.

Optionally, acquiring the extrinsic matrix of the camera is by:
using an auxiliary camera to determine the extrinsic matrix of the camera.

Optionally, using the auxiliary camera to determine the extrinsic matrix of the camera, includes:
acquiring an extrinsic matrix of the camera in the camera coordinate system relative to a world coordinate system to obtain a first extrinsic matrix;
acquiring an extrinsic matrix of the auxiliary camera in an auxiliary camera coordinate system relative to the world coordinate system to obtain a second extrinsic matrix, where the auxiliary camera is configured to assist in determining the extrinsic matrix of the camera;
acquiring an extrinsic matrix of the auxiliary camera in the camera coordinate system based on the first extrinsic matrix and the second extrinsic matrix to obtain a third extrinsic matrix;
capturing an image displayed on the display with the auxiliary camera during display of the image on the display to obtain a captured image, and acquiring an extrinsic matrix of the display in the auxiliary camera coordinate system from the captured image to obtain a fourth extrinsic matrix; and
acquiring an extrinsic matrix of the display in the camera coordinate system based on the third extrinsic matrix and the fourth extrinsic matrix to obtain the extrinsic matrix of the camera.

According to a second aspect of embodiments of the present disclosure, there is provided a method of acquiring a training sample set, including:
randomly displaying a preset marker on a display; and
in response to detecting that the preset marker is triggered, controlling a camera to capture a sample image involving a face of a user, where the sample image has a calibrated gaze vector matched with a position of the preset marker.

Optionally, randomly displaying the preset marker on the display, includes:
dividing a display area of the display into n*n sub-display areas; and
randomly displaying the preset marker on the display in each of the sub-display areas.

Optionally, randomly displaying the preset marker on the display in each of the sub-display areas, includes:
acquiring a display duration that the preset marker is displayed in the sub-display area during display of the preset marker; and
in response to the preset marker being triggered or the display duration being equal to a preset duration and the preset marker being not triggered, stopping displaying a current preset marker and displaying a next preset marker.

Optionally, the preset marker contains a preset content, and detecting that the preset marker is triggered, includes:
receiving a trigger mode signal for a triggered position; and
in response to the trigger mode signal being matched with the preset content, determining that the preset marker is detected to be triggered.

Optionally, the preset content includes a first preset content and a second preset content, the trigger mode signal includes a first trigger mode and a second trigger mode, the first trigger mode is matched with the first preset content, and the second trigger mode is matched with the second preset content.

According to a third aspect of embodiments of the present disclosure, there is provided an apparatus for acquiring a gaze point, including:
an original image acquiring module, configured to acquire an original image of a user from a camera;
an image and matrix acquiring module, configured to acquire a left-eye image of a left eye of the user, a right-eye image of a right eye of the user, a face image of a face of the user, and a head-camera rotation matrix from the original image, where the head-camera rotation matrix represents a rotation of a head of the user relative to the camera;
a gaze vector acquiring module, configured to acquire a gaze vector of the left eye and the right eye in a camera coordinate system from the left-eye image, the right-eye image, the face image, and the head-camera rotation matrix; and
a gaze point acquiring module, configured to acquire a gaze point of the user on a display from the gaze vector, physical parameters of the display and an extrinsic matrix of the camera, where the extrinsic matrix of the camera represents a transformation between a display coordinate system and the camera coordinate system.

Optionally, the image and matrix acquiring module includes:
an intrinsic matrix acquiring submodule, configured to acquire an intrinsic matrix of the camera;
a head pose acquiring submodule, configured to acquire head pose data from the original image; and
an image acquiring submodule, configured to acquire the left-eye image, the right-eye image, and the face image, respectively, from the original image, the intrinsic matrix, and the head pose data, where the left-eye image is a front-view image centered at a center of the left eye, the right-eye image is a front-view image centered at a center of the right eye, and the face image is a front-view image centered at a center of the face.

Optionally, the image and matrix acquiring module further includes:
a grayscale image acquiring submodule, configured to obtain a left-eye grayscale image and a right-eye grayscale image from the left-eye image and the right-eye image, respectively.

Optionally, the head pose acquiring submodule includes:
a keypoint acquiring unit, configured to input the original image into a preset keypoint detection model to obtain 2D keypoint coordinates in the camera coordinate system; and
a head pose acquiring unit, configured to input preset 3D keypoint coordinates in a head coordinate system and the 2D keypoint coordinates into a preset perspective projection model, to acquire, from the preset perspective projection model, a rotation matrix and a displacement matrix of the head relative to the camera as the head pose data.

Optionally, the preset keypoint detection model is configured to detect a preset number of keypoints of the face of the user from the original image, where the preset number is more than 106.

Optionally, the image acquiring submodule includes:
a face matrix acquiring unit, configured to acquire, from the head pose data, a face transformation matrix;
a left-eye matrix acquiring unit, configured to acquire, from the head pose data, a left-eye transformation matrix;
a right-eye matrix acquiring unit, configured to acquire, from the head pose data, a right-eye transformation matrix;
a left-eye image acquiring unit, configured to acquire the left-eye image from the original image and the left-eye transformation matrix;
a right-eye image acquiring unit, configured to acquire the right-eye image from the original image and the right-eye transformation matrix; and
a face image acquiring unit, configured to acquire the face image from the original image and the face transformation matrix.

Optionally, the face matrix acquiring unit includes:
a Z-axis acquiring subunit, configured to adjust an origin of a Z-axis of the camera coordinate system to be an origin of the head coordinate system such that the camera directly faces a center point of the face;
a Y-axis adjusting subunit, configured to adjust an X-axis of the camera coordinate system to be parallel to an X-axis of the head coordinate system such that the head remains horizontal in the camera coordinate system to obtain a Y-axis of the camera coordinate system;
an X-axis adjusting subunit, configured to acquire the X-axis of the camera coordinate system from the Z-axis and the Y-axis of the camera coordinate system to obtain a face rotation matrix;
an initial matrix acquiring subunit, configured to obtain an initial face transformation matrix from the face rotation matrix and a preset scaling matrix; and
a face matrix acquiring subunit, configured to acquire, from the intrinsic matrix, a target camera matrix and the initial face transformation matrix, the face transformation matrix of the target camera matrix with respect to an original camera matrix.

Optionally, the left-eye matrix acquiring unit includes:
a Z-axis acquiring subunit, configured to adjust an origin of a Z-axis of the camera coordinate system to be an origin of a left-eye coordinate system such that the camera directly faces a center point of the left eye;
a Y-axis adjusting subunit, configured to adjust an X-axis of the camera coordinate system to be parallel to an X-axis of the left-eye coordinate system such that the left eye remains horizontal in the camera coordinate system to obtain a Y-axis of the camera coordinate system;
an X-axis adjusting subunit, configured to acquire the X-axis of the camera coordinate system from the Z-axis and the Y-axis of the camera coordinate system to obtain a left-eye rotation matrix;
an initial matrix acquiring subunit, configured to obtain an initial left-eye transformation matrix from the left-eye rotation matrix and a preset scaling matrix; and
a left-eye matrix acquiring subunit, configured to acquire, from the intrinsic matrix, a target camera matrix and the initial left-eye transformation matrix, the left-eye transformation matrix of the target camera matrix with respect to an original camera matrix.

Optionally, the right-eye matrix acquiring unit includes:
a Z-axis acquiring subunit, configured to adjust an origin of a Z-axis of the camera coordinate system to be an origin of a right-eye coordinate system such that the camera directly faces a center point of the right eye;
a Y-axis adjusting subunit, configured to adjust an X-axis of the camera coordinate system to be parallel to an X-axis of the right-eye coordinate system such that the right eye remains horizontal in the camera coordinate system to obtain a Y-axis of the camera coordinate system;
an X-axis adjusting subunit, configured to acquire the X-axis of the camera coordinate system from the Z-axis and the Y-axis of the camera coordinate system to obtain a right-eye rotation matrix;
an initial matrix acquiring subunit, configured to obtain an initial right-eye transformation matrix from the right-eye rotation matrix and a preset scaling matrix; and
a right-eye matrix acquiring subunit, configured to acquire, from the intrinsic matrix, a target camera matrix and the initial right-eye transformation matrix, the right-eye transformation matrix of the target camera matrix with respect to an original camera matrix.

Optionally, the gaze vector acquiring module includes:
a feature for guidance acquiring submodule, configured to acquire a feature for guidance from the face image and the head-camera rotation matrix;
a left-eye feature acquiring submodule, configured to acquire a left-eye feature from the left-eye grayscale image;
a right-eye feature acquiring submodule, configured to acquire a right-eye feature from the right-eye grayscale image;
a corrected feature acquiring submodule, configured to correct the left-eye feature and the right-eye feature with the feature for guidance to obtain a corrected feature; and
a gaze vector acquiring submodule, configured to splice the feature for guidance and the corrected feature and perform fully connected processing on the spliced feature to obtain a yaw angle and a pitch angle of the head in the camera coordinate system as the gaze vector.

Optionally, the feature for guidance acquiring submodule includes:
a facial feature extracting unit, configured to extract a facial feature from the face image;
a head-camera feature acquiring unit, configured to perform fully connected processing on the head-camera rotation matrix to obtain a head-camera feature; and
a feature for guidance acquiring unit, configured to splice the facial feature and the head-camera feature to obtain the feature for guidance.

Optionally, the left-eye feature acquiring submodule includes:
a network model acquiring unit, configured to acquire a preset feature extraction network model, where the feature extraction network model is a ResNet-18 model; and
a left-eye feature acquiring unit, configured to input the left-eye grayscale image into the feature extraction network model to obtain the left-eye feature from the left-eye grayscale image; and
the right-eye feature acquiring submodule includes:
a network model acquiring unit, configured to acquire a preset feature extraction network model, where the feature extraction network model is a ResNet-18 model; and
a right-eye feature acquiring unit, configured to input the right-eye grayscale image into the feature extraction network model to obtain the right-eye feature from the right-eye grayscale image.

Optionally, the corrected feature acquiring submodule includes:
an corrected eye feature acquiring unit, configured to correct the left-eye feature and the right-eye feature with the feature for guidance to obtain a corrected left-eye feature and a corrected right-eye feature, respectively;
a spliced feature acquiring unit, configured to splice the corrected left-eye feature and the corrected right-eye feature to obtain the spliced feature;
an adjusted feature acquiring unit, configured to perform weight adjustment processing on the spliced feature to obtain an adjusted feature; and
a corrected feature acquiring unit, configured to correct the adjusted feature with the feature for guidance to obtain the corrected feature.

Optionally, the corrected eye feature acquiring unit includes:
a preset model acquiring subunit, configured to acquire a preset AdaGN module having the feature for guidance as input data;
a target model acquiring subunit, configured to input the feature for guidance into the preset AdaGN module to adjust a parameter value of the AdaGN module and obtain a target AdaGN module; and
an eye feature correcting subunit, configured to correct the left-eye feature and the right-eye feature with the target AdaGN module to obtain the corrected left-eye feature and the corrected right-eye feature, respectively.

Optionally, the gaze vector acquiring module includes:
a gaze vector acquiring submodule, configured to input the left-eye grayscale image, the right-eye grayscale image, the face image, and the head-camera rotation matrix into a preset gaze tracking model to obtain the gaze vector in the camera coordinate system from the preset gaze tracking model.

Optionally, the apparatus further includes a tracking model training module configured to train the preset gaze tracking model. The tracking model training module includes:
a sample set acquiring submodule, configured to acquire a preset sample set, where the preset sample set includes a pre-collected training sample set, and each sample in the preset sample set includes a calibrated gaze vector;
an estimated vector acquiring submodule, configured to input each sample in the preset sample set into an initial gaze tracking model to obtain an estimated gaze vector from the initial gaze tracking model;
a function value determining submodule, configured to determine a value of a loss function from the estimated gaze vector and the calibrated gaze vector of each sample; and
a tracking model acquiring submodule, configured to in response to a difference between two adjacent values of the loss function being greater than a preset difference threshold, return to the operation of inputting each sample in the preset sample set into the initial gaze tracking model until the difference is less than or equal to the preset difference threshold, to obtain the preset gaze tracking model.

Optionally, the function value determining submodule includes:
a similarity acquiring unit, configured to acquire a similarity between the estimated gaze vector and the calibrated gaze vector of each sample; and
a value determining unit, configured to determine a difference between a constant value and the similarity as the value of the loss function.

Optionally, the sample set acquiring submodule includes:
a preset marker display unit, configured to randomly display a preset marker on the display; and
a sample image capturing unit, configured to in response to detecting that the preset marker is triggered, control the camera to capture a sample image involving the face of the user, where the sample image has a calibrated gaze vector matched with a position of the preset marker.

Optionally, the preset marker display unit includes:
a display area dividing subunit, configured to divide a display area of the display into n*n sub-display areas; and
a preset marker display subunit, configured to randomly display the preset marker on the display in each of the sub-display areas.

Optionally, the preset marker display subunit includes:
a display duration acquiring sub-subunit, configured to acquire a display duration that the preset marker is displayed in the sub-display area during display of the preset marker; and
a preset marker display sub-subunit, configured to in response to the preset marker being triggered or the display duration being equal to a preset duration and the preset marker being not triggered, stop displaying a current preset marker and display a next preset marker.

Optionally, the preset marker contains a preset content, and the sample image capturing unit includes:
a trigger mode acquiring subunit, configured to receive a trigger mode signal for a triggered position; and
a marker trigger subunit, configured to in response to the trigger mode signal being matched with the preset content, determine that the preset marker is detected to be triggered.

Optionally, the preset content includes a first preset content and a second preset content, the trigger mode signal includes a first trigger mode and a second trigger mode, the first trigger mode is matched with the first preset content, and the second trigger mode is matched with the second preset content.

Optionally, the apparatus further includes:
a calibration vector acquiring module, configured to acquire a user calibration vector corresponding to the user in the original image; and
a gaze vector update module, configured to calibrate the gaze vector with the user calibration vector to obtain an updated gaze vector.

Optionally, the calibration vector acquiring module includes:
a preset marker display submodule, configured to display a preset marker on the display;
a ground-truth vector acquiring submodule, configured to in response to detecting that the preset marker is triggered, acquiring a ground-truth vector corresponding to the preset marker, where the ground-truth vector is related to coordinate data of the preset marker and a distance between the camera and the display; and
a calibration vector determining submodule, configured to determine a difference between the ground-truth vector and the gaze vector as the user calibration vector.

Optionally, the preset marker display submodule includes:
a preset marker display unit, configured to sequentially display the preset marker at a plurality of designated positions of the display; and
a display stopping unit, configured to stop displaying the preset marker in response to the preset marker being triggered or a display duration of the preset marker being equal to a preset duration; and
the preset marker display unit is further configured to display the preset marker at a next designated position randomly selected until the preset marker is displayed once at each of the designate positions.

Optionally, the gaze point acquiring module includes:
a coordinate data determining submodule, configured to determine coordinate data of the display in the camera coordinate system based on the extrinsic matrix of the camera and the physical parameters of the display; and
a gaze point acquiring submodule, configured to acquire, from the gaze vector, coordinates of a center point of the face, and the coordinate data, an intersection point of the gaze vector with the display as the gaze point.

Optionally, the coordinate data determining submodule includes:
an extrinsic matrix acquiring unit, configured to use an auxiliary camera to determine the extrinsic matrix of the camera.

Optionally, the extrinsic matrix acquiring unit includes:
a first extrinsic matrix acquiring subunit, configured to acquire an extrinsic matrix of the camera in the camera coordinate system relative to a world coordinate system to obtain a first extrinsic matrix;
a second extrinsic matrix acquiring subunit, configured to acquire an extrinsic matrix of the auxiliary camera in an auxiliary camera coordinate system relative to the world coordinate system to obtain a second extrinsic matrix, where the auxiliary camera is configured to assist in determining the extrinsic matrix of the camera;
a third extrinsic matrix acquiring subunit, configured to acquire an extrinsic matrix of the auxiliary camera in the camera coordinate system based on the first extrinsic matrix and the second extrinsic matrix to obtain a third extrinsic matrix;
a fourth extrinsic matrix acquiring subunit, configured to capture an image displayed on the display with the auxiliary camera during display of the image on the display to obtain a captured image, and acquire an extrinsic matrix of the display in the auxiliary camera coordinate system from the captured image to obtain a fourth extrinsic matrix; and
an extrinsic matrix acquiring subunit, configured to acquire an extrinsic matrix of the display in the camera coordinate system based on the third extrinsic matrix and the fourth extrinsic matrix to obtain the extrinsic matrix of the camera.

According to a fourth aspect of embodiments of the present disclosure, there is provided an apparatus for acquiring a training sample set, including:
a preset marker control module, configured to randomly display a preset marker on a display; and
a sample image acquiring module, configured to in response to detecting that the preset marker is triggered, control a camera to capture a sample image involving a face of a user, where the sample image has a calibrated gaze vector matched with a position of the preset marker.

According to a fifth aspect of embodiments of the present disclosure, there is provided an electronic device, including:
a camera;
a display;
a processor; and
a non-transitory memory for storing a computer program executable by the processor,
where the processor is configured to execute the computer program in the memory to implement the method according to the first aspect or the second aspect.

According to a sixth aspect of embodiments of the present disclosure, there is provided a non-transitory computer-readable storage medium, where when an executable computer program in the storage medium is executed by a processor, the method according to the first aspect or the second aspect is implemented.

Technical solutions according to embodiments of the present disclosure may include the following beneficial effects.

As can be seen from the above embodiments, with the solutions according to the embodiments of the present disclosure, an original image may be acquired from a camera without addition of any expensive image devices, thereby reducing the hardware cost and the complexity of the solutions. A left-eye image, a right-eye image, a face image, and a head-camera rotation matrix are then acquired from the original image, and a gaze vector of a left eye and a right eye in a camera coordinate system is acquired from the left-eye image, the right-eye image, the face image, and the head-camera rotation matrix. Compared with the scheme in which a gaze vector is acquired from an RGB image, use of a left-eye grayscale image and a right-eye grayscale image can reduce the amount of data processing and improve the processing speed. Finally, a gaze point of the user on a display is acquired from the gaze vector, physical parameters of the display, and an extrinsic matrix of the camera. Compared with direct output of a gaze point, acquiring the gaze point after the gaze vector can be applied to different displays, which expands applicable scenes of the present disclosure.

It is to be understood that the above general description and the following detailed description are exemplary and explanatory only and are not intended to limit the present disclosure.

### BRIEF DESCRIPTION OF DRAWINGS

The accompanying drawings, which are incorporated into and constitute a part of this specification, illustrate embodiments consistent with the present disclosure and, together with the specification, serve to explain the principles of the present disclosure.

FIG. 1 is a flowchart illustrating a method of acquiring a gaze point according to an exemplary embodiment.

FIG. 2 is a flowchart illustrating acquisition of a left-eye grayscale image and a right-eye grayscale image according to an exemplary embodiment.

FIG. 3 is a flowchart illustrating acquisition of head pose data according to an exemplary embodiment.

FIG. 4 is a schematic diagram illustrating a 2D keypoint of a face according to an exemplary embodiment.

FIG. 5 is a schematic diagram illustrating a 3D keypoint of a face according to an exemplary embodiment.

FIG. 6 is a flowchart illustrating acquisition of a face transformation matrix according to an exemplary embodiment.

FIG. 7 is a schematic diagram illustrating acquisition of a face rotation matrix R according to an exemplary embodiment.

FIG. 8 is a schematic diagram illustrating a distance between a camera and an eye according to an example embodiment.

FIG. 9 is a schematic diagram illustrating a head rotation according to an exemplary embodiment.

FIG. 10 is a flowchart illustrating acquisition of a left-eye transformation matrix according to an exemplary embodiment.

FIG. 11 is a flowchart illustrating acquisition of a right-eye transformation matrix according to an exemplary embodiment.

FIG. 12 is a schematic diagram illustrating an original right-eye image and a right-eye grayscale image according to an exemplary embodiment.

FIG. 13 is a flowchart illustrating acquisition of a gaze vector according to an exemplary embodiment.

FIG. 14 is a flowchart illustrating acquisition of a preset gaze tracking model according to an exemplary embodiment.

FIG. 15 is a flowchart illustrating acquisition of a sample image according to an exemplary embodiment.

FIG. 16 is a schematic diagram illustrating display of a preset marker on a display according to an exemplary embodiment.

FIG. 17 is a schematic structural diagram illustrating a preset gaze tracking model according to an exemplary embodiment.

FIG. 18 is a schematic diagram illustrating a position relation between a camera and a display, that is, an extrinsic matrix, according to an exemplary embodiment.

FIG. 19 is a flowchart illustrating acquisition of an extrinsic matrix of a camera according to an exemplary embodiment.

FIG. 20 is a schematic diagram illustrating acquisition of an extrinsic matrix of a camera with an auxiliary camera according to an exemplary embodiment.

FIG. 21 is a schematic diagram illustrating display of a gaze point on a display according to an exemplary embodiment.

FIG. 22 is a schematic diagram illustrating an estimated gaze vector and a ground-truth gaze vector according to an exemplary embodiment.

FIG. 23 is a flowchart illustrating update of a gaze vector according to an exemplary embodiment.

FIG. 24 is a flowchart illustrating acquisition of a user calibration vector according to an exemplary embodiment.

FIG. 25 is a schematic diagram illustrating display of a preset marker on a display according to an exemplary embodiment.

FIG. 26 is a block diagram illustrating an apparatus for acquiring a gaze point according to an exemplary embodiment.

### DETAILED DESCRIPTION

Reference will now be made in detail to exemplary embodiments, examples of which are illustrated in the accompanying drawings. When the following description refers to the drawings, the same numerals in different drawings indicate the same or similar elements, unless otherwise indicated. The exemplary embodiments described below are not intended to represent all embodiments consistent with the present disclosure. Rather, they are merely examples of apparatuses consistent with some aspects of the present disclosure as detailed in the appended claims. It should be noted that features in the following embodiments and implementations may be combined with each other without conflict.

In order to solve the above technical problems, embodiments of the present disclosure provide a method of acquiring a gaze point, which can be applied to an electronic device provided with a camera, such as a smart phone, a tablet computer, a personal computer, or a display device provided with a camera. The camera may include, but is not limited to, a monocular camera or a binocular camera. For convenience of description, a monocular camera is used as an example to describe various solutions in subsequent embodiments of the present disclosure, but the present disclosure is not limited thereto. The electronic device has the monocular camera in a fixed position with respect to a display, such that an extrinsic matrix of the monocular camera remains unchanged.

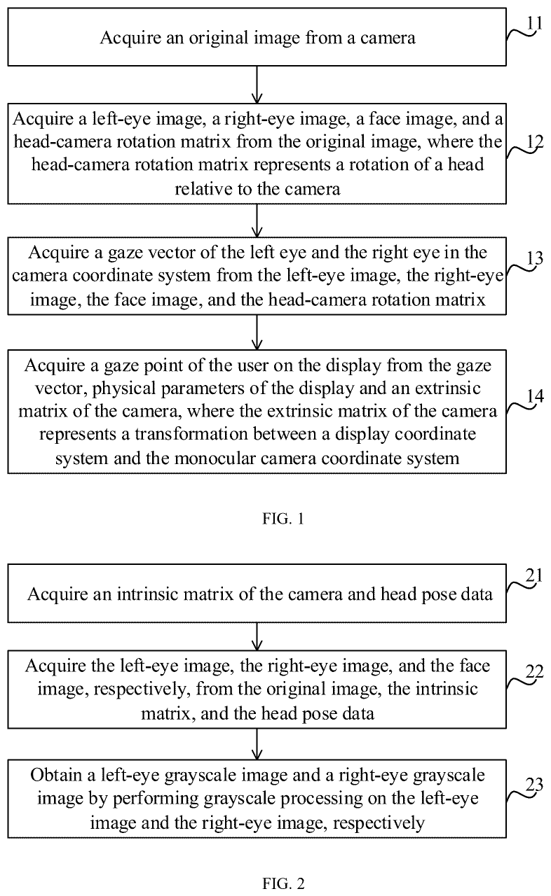

FIG. 1 is a flowchart illustrating a method of acquiring a gaze point according to an exemplary embodiment. Referring to FIG. 1, a method of acquiring a gaze point includes steps 11 to 14.

At step 11, an original image of a user is acquired from a camera.

In this embodiment, a processor of the electronic device may acquire an original image from the monocular camera. The monocular camera may capture an RGB image in a preset scene, which is called an original image subsequently to show a difference. In an example, the monocular camera, after capturing the RGB image, may store the RGB image in a designated location, such as a local memory, a cache, or the cloud, such that the processor may read the original image from the designated location. In another example, the monocular camera may be in communication with the processor, and upon receiving an acquisition request from the processor, the monocular camera may capture the original image and feed it back to the processor. It is to be understood that those skilled in the art may select a method of acquiring the original image according to a specific scene, and the corresponding scheme falls within the scope of protection of the present disclosure.

At step 12, a left-eye image of a left eye of the user, a right-eye image of a right eye of the user, a face image of a face of the user, and a head-camera rotation matrix are acquired from the original image, where the head-camera rotation matrix represents a rotation of a head of the user relative to the camera.

In this embodiment, the processor may acquire a left-eye image, a right-eye image, a face image, and a head-camera rotation matrix from the original image, which includes steps 21 and 22, as shown in FIG. 2.

At step 21, the processor may acquire an intrinsic matrix of the camera and acquire head pose data from the original image.

In this step, the processor may acquire an intrinsic matrix of the monocular camera. The intrinsic matrix may be realized based on a pinhole imaging model, where light reflected from an object in the physical world passes through a pinhole of the camera to form an inverted image in an image plane of the camera. Due to different focal lengths, principal point offset, skewed or non-square image sensor, lens distortion and other factors, there may be differences in camera imaging. In this case, a 3×3 intrinsic matrix may be pre-calibrated to characterize the above differences. In this step, the Zhang Zhengyou calibration method is used, where a plurality of checkerboards at different angles are captured to obtain a plurality of images, and then the plurality of images are used to calculate the intrinsic matrix.

Eyes, when looking straight ahead, gaze at different positions with the head facing forward and with the head tilted to the side. The head is a 3D rigid body, which has and only has two kinds of movements with respect to the camera, that is, rotation and translation. Therefore, in this step, the processor may pre-acquire a rotation matrix R (3×3) and a translation matrix T (3×1) of the head with respect to the monocular camera.

In this step, the electronic device may store a preset keypoint detection model, such as a convolutional pose machine, which may be selected according to a specific scene. In this step, the preset keypoint detection model is configured to detect a preset number of keypoints of a face of the user from the original image. The preset number is more than 106. Moreover, in this step, the preset number of keypoints are located in areas that are less susceptible to facial expressions, such as an eye area, an area around the eyes, a nasal bone area, or an area around the face, while keypoints in a mouth area, a chin area, and a risorius area are discarded, so as to better characterize the head and obtain more stable head pose data, which may also be used for accurate center points of the left eye, the right eye, and the face.

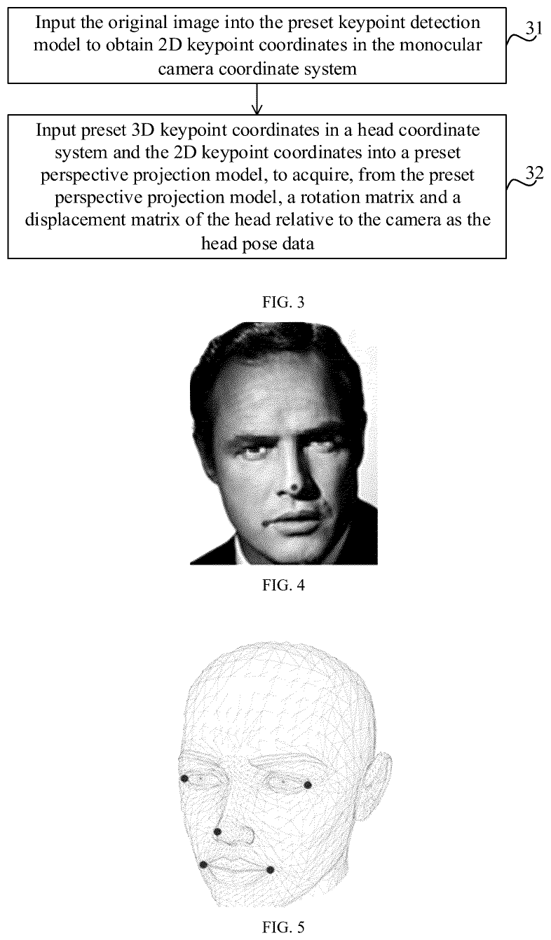

In an example, referring to FIG. 3, at step 31, the processor may input the original image into the preset keypoint detection model, which may process the original image and output keypoint data of the face. That is, the processor may obtain 2D keypoint coordinates of the face of the user in the camera coordinate system, as shown in FIG. 4.

At step 32, the processor may input preset 3D keypoint coordinates in a head coordinate system as shown in FIG. 5 and the above 2D keypoint coordinates into a preset perspective projection model. The preset perspective projection model may include, but is not limited to, a SolvePnP algorithm such as P3P, DLT, EPnP, or UPnP. For convenience of description, the SolvePnP algorithm will be used hereinafter to replace the preset perspective projection model to describe the solutions of various embodiments. Then, a rotation matrix (3*3) and a displacement matrix (3*1) of the head with respect to the monocular camera are acquired from the preset SolvePnP algorithm as the head pose data. It should be noted that at least four pairs of 2D keypoint coordinates are used in obtaining the rotation matrix of the head with respect to the monocular camera from the SolvePnP algorithm, but the larger the number of the 2D keypoint coordinates used, the more accurate the calculation result is, which is not particularly limited in the present disclosure. In this way, in this example, a mapping relation between the head in the original image and 3D keypoints of the head in the head coordinate system can be obtained, and the pose of the head in the original image can be obtained, so as to facilitate subsequent head correction.

At step 22, the processor may acquire the left-eye image, the right-eye image, and the face image, respectively, from the original image, the intrinsic matrix, and the head pose data, where the left-eye image is a front-view image centered at a center of the left eye, the right-eye image is a front-view image centered at a center of the right eye, and the face image is a front-view image centered at a center of the face.

In this step, the processor may acquire the left-eye image, the right-eye image, and the face image, respectively, from the original image, the intrinsic matrix, and the head pose data. In an example, the processor may acquire, from the head pose data, a face transformation matrix, a left-eye transformation matrix, and a right-eye transformation matrix. The processor may then acquire the left-eye image from the original image and the left-eye transformation matrix, acquire the right-eye image from the original image and the right-eye transformation matrix, and acquire the face image from the original image and the face transformation matrix.

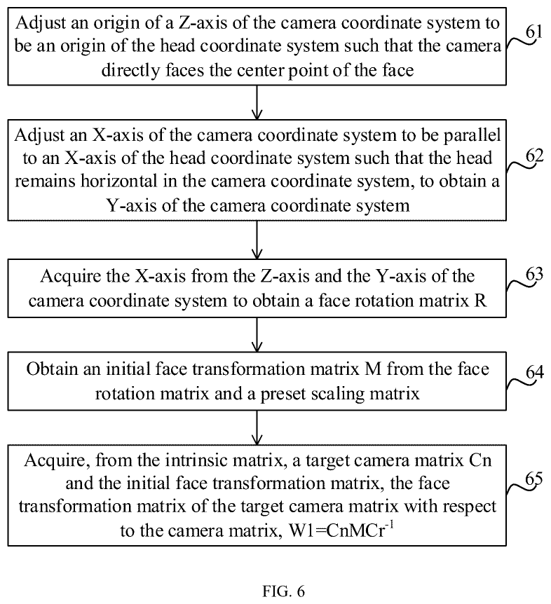

For example, in the case that the face transformation matrix is acquired from the head pose data, steps 61 to 65 are included, as shown in FIG. 6.

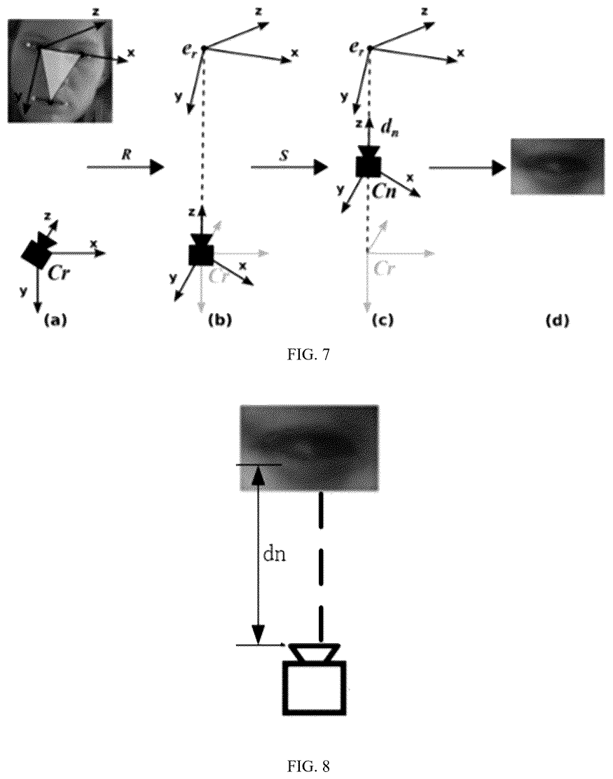

At step 61, the processor may adjust an origin of a Z-axis of the camera coordinate system to be an origin of the head coordinate system such that the camera directly faces the center point of the face. Referring to FIG. 7, (a) in FIG. 7 illustrates a face coordinate system eᵣxyz and a monocular camera system Cr. At this point, in order to obtain the effect that the monocular camera directly faces the center point of the face, the Z-axis of the monocular camera. Zc, has to be eᵣ, that is, an origin of Zc is at eᵣ. The center point of the face can be obtained by acquiring two corner points of the left eye, two corner points of the right eye, and two corner points of the mouth, and then acquiring an average of coordinates of the above six corner points. In an example, considering the large number of keypoints of the face (up to 106), more accurate center points of the eyes may be obtained in this example by obtaining an average of keypoints around the left eye to calculate the center point of the left eye, and an average of keypoints around the right eye to calculate the center point of the right eye.

At step 62, the processor may adjust an X-axis of the camera coordinate system to be parallel to an X-axis of the head coordinate system such that the head remains horizontal in the camera coordinate system, to obtain a Y-axis of the camera coordinate system. In this step, in order to remain the head horizontal in the camera (that is, to eliminate a Roll angle), the X-axis of the head system, Xh, needs to be parallel to the X-axis of the camera system, Xc, and thus the Y-axis of the camera coordinate system, Yc, satisfies Yc=Zc×Xh, where the operation symbol “×” denotes a cross-product operation. With continued reference to FIG. 7, (b) in FIG. 7 illustrates elimination of the Roll angle of the face, and processing of image coordinates of the face area such that the Z-axis of the monocular camera directly faces the center point of the face.

At step 63, the processor may acquire the X-axis of the camera coordinate system from the Z-axis and the Y-axis of the camera coordinate system to obtain a face rotation matrix R.

In this step, the processor may acquire, from the Z-axis and the Y-axis of the camera coordinate system, the X-axis Xc=Yc×Zc, so as to obtain the rotation matrix

$$R = [ \frac{{X}_{c}}{‖ {X}_{c} ‖} , \frac{{Y}_{c}}{‖ {Y}_{c} ‖} , \frac{{Z}_{c}}{‖ {Z}_{c} ‖} ] ,$$

where ∥·∥ denotes a modulo operation that yields a vector with a length of 1.

At step 64, the processor may obtain an initial face transformation matrix M from the face rotation matrix and a preset scaling matrix.

In this step, a preset scaling matrix

$$S = diag ( 1 , 1 , \frac{{d}_{n}}{‖ {e}_{r} ‖} )$$

may be stored in the electronic device in consideration of the fact that scaling, when performed on an image, has little effect on pixels. Where dₙ denotes a distance from the monocular camera to the eye, which is a known preset distance, as shown in FIG. 8, eᵣ denotes a center vector of the face, and diag denotes a diagonal matrix. With continued reference to FIG. 7, (c) in FIG. 7 illustrates elimination of the effect of distances on images when the camera captures the images, that is, normalization of distances between the camera and faces to a common preset distance dₙ.

Thus, the processor may calculate the product of the rotation matrix R and the scaling matrix S, to obtain the initial face transformation matrix M=SR.

At step 65, the processor may acquire, from the intrinsic matrix, a target camera matrix Cn and the initial face transformation matrix, the face transformation matrix of the target camera matrix with respect to an original camera matrix, W1=CnMCr⁻¹. Cr is an original camera projection matrix obtained from camera calibration, and Cn is a camera projection matrix defined for the normalized camera. The target camera matrix Cn is a preset virtual camera matrix with empirical values set to normalize cameras, with the aim of normalizing different camera parameters to the same camera parameters, eliminating the influence of the camera parameters such as the focal length.

With continued reference to FIG. 7, (d) in FIG. 7 illustrates an image after perspective transformation through the face transformation matrix. It should be noted that FIG. 7 illustrates an example in which the face is represented by the right eye, which is only for the convenience of understanding the process of acquiring the face transformation matrix in the solution, with the difference in that the face coordinate system is established based on the center of the face, while the right-eye coordinate system is established based on the center of the right eye.

In this step, the processor may acquire, from the intrinsic matrix, the target camera matrix Cn and the initial face transformation matrix, the face transformation matrix of the target camera matrix with respect to the original camera matrix, W1=CnMCr⁻¹.

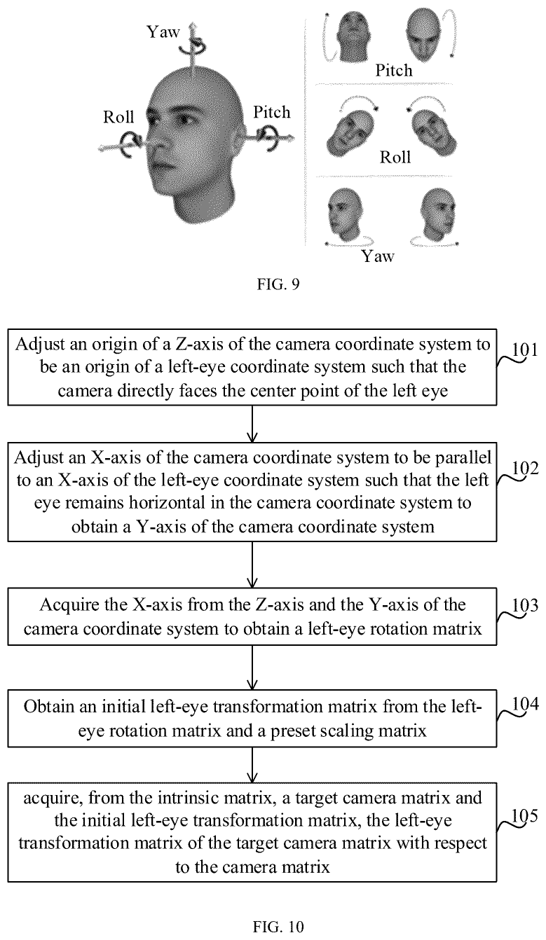

It is to be understood that the above face transformation matrix may rotate the head of the user in the original image and acquire the face image of the user with the face kept in the middle of the face image, thereby eliminating the influence of a Roll angle on the eyes and reducing the difficulty in the subsequent learning process. The head rotation pose is shown in FIG. 9.

For example, in the case that the left-eye transformation matrix is acquired from the head pose data, steps 101 to 105 are included, as shown in FIG. 10.

At step 101, the processor may adjust an origin of a Z-axis of the camera coordinate system to be an origin of a left-eye coordinate system such that the camera directly faces the center point of the left eye. It can be understood that step 101 is similar to step 61, with the difference in that the face coordinate system becomes the left-eye coordinate system with the center point of the left eye as the origin, and the camera directly faces the center point of the left eye.

At step 102, the processor may adjust an X-axis of the camera coordinate system to be parallel to an X-axis of the left-eye coordinate system such that the left eye remains horizontal in the camera coordinate system to obtain a Y-axis of the camera coordinate system. It can be understood that step 102 is similar to step 62 except that the X-axis of the camera coordinate system is parallel to the X-axis of the left-eye coordinate system.

At step 103, the processor may acquire the X-axis of the camera coordinate system from the Z-axis and the Y-axis of the camera coordinate system to obtain a left-eye rotation matrix. It can be understood that step 103 is the same as step 63, and will not be repeated herein.

At step 104, the processor may obtain an initial left-eye transformation matrix from the left-eye rotation matrix and a preset scaling matrix. It can be understood that step 104 is the same as step 64, and will not be repeated herein.

At step 105, the processor may acquire, from the intrinsic matrix, a target camera matrix and the initial left-eye transformation matrix, the left-eye transformation matrix of the target camera matrix with respect to an original camera matrix, W2=CnMCr⁻¹. It can be understood that step 105 is the same as step 65, and will not be repeated herein.

It is to be understood that the above left-eye transformation matrix may rotate the left eye in the original image and acquire the left-eye image of the user with the left eye in the middle of the left-eye image, thereby eliminating the influence of a Roll angle on the left eye and reducing the difficulty in the subsequent learning process.

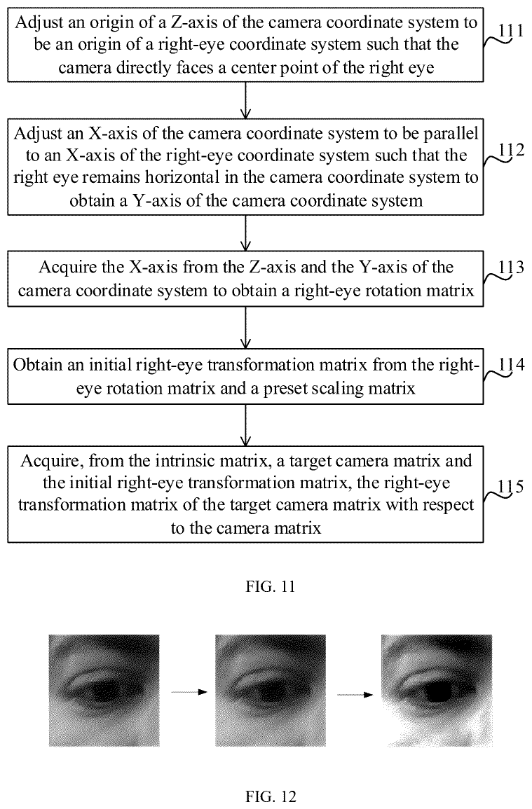

For example, in the case that the right-eye transformation matrix is acquired from the head pose data, steps 111 to 115 are included, as shown in FIG. 11.

At step 111, the processor may adjust an origin of a Z-axis of the camera coordinate system to be an origin of a right-eye coordinate system such that the camera directly faces a center point of the right eye. It can be understood that step 111 is similar to step 61, with the difference in that the face coordinate system becomes the right-eye coordinate system with the center point of the right eye as the origin, and the camera directly faces the center point of the right eye.

At step 112, the processor may adjust an X-axis of the camera coordinate system to be parallel to an X-axis of the right-eye coordinate system such that the right eye remains horizontal in the camera coordinate system to obtain a Y-axis of the camera coordinate system. It can be understood that step 112 is similar to step 62 except that the X-axis of the camera coordinate system is parallel to the X-axis of the right-eye coordinate system.

At step 113, the processor may acquire the X-axis of the camera coordinate system from the Z-axis and the Y-axis of the camera coordinate system to obtain a right-eye rotation matrix. It can be understood that step 113 is the same as step 63, and will not be repeated herein.

At step 114, the processor may obtain an initial right-eye transformation matrix from the right-eye rotation matrix and a preset scaling matrix. It can be understood that step 114 is the same as step 64, and will not be repeated herein.

At step 115, the processor may acquire, from the intrinsic matrix, a target camera matrix and the initial right-eye transformation matrix, the right-eye transformation matrix of the target camera matrix with respect to an original camera matrix, W2=CnMCr⁻¹. It can be understood that step 115 is the same as step 65, and will not be repeated herein.

It is to be understood that the above right-eye transformation matrix may rotate the right eye in the original image and acquire the right-eye image of the user with the right eye in the middle of the right-eye image, thereby eliminating the influence of a Roll angle on the right eye and reducing the difficulty in the subsequent learning process.

In this step, the processor may acquire the left-eye image from the original image and the left-eye transformation matrix, acquire the right-eye image from the original image and the right-eye transformation matrix, and acquire the face image from the original image and the face transformation matrix. That is, the processor may multiply the original image by the left-eye transformation matrix, the right-eye transformation matrix, and the face transformation matrix, respectively, to obtain the left-eye image, the right-eye image, and the face image. It is to be understood that the left-eye image, the right-eye image, and the face image are all RGB images.

In an example, the embodiment shown in FIG. 2 further includes step 23 in which the processor may obtain a left-eye grayscale image and a right-eye grayscale image by performing grayscale processing on the left-eye image and the right-eye image, respectively. In this step, considering that the gaze point is only related to position information of the eye portion relative to the portion around the eye, and is not related to color information such as pupil color and skin color, only grayscale information is retained for the left-eye image and the right-eye image in this step, thereby reducing the subsequent calculation amount. Moreover, in this step, the left-eye image and the right-eye image are subjected to grayscale processing such as, for example, histogram equalization, maximum value method, average value method, or weighted average method to obtain the left-eye grayscale image and the right-eye grayscale image, enabling more obvious position movement information of the eye portion. For example, in the case of the right eye, referring to FIG. 12, the left is an original right-eye image, the middle is a right-eye grayscale image, and the right is a right-eye grayscale histogram.

At step 13, a gaze vector of the left eye and the right eye in the camera coordinate system is acquired from the left-eye image, the right-eye image, the face image, and the head-camera rotation matrix.

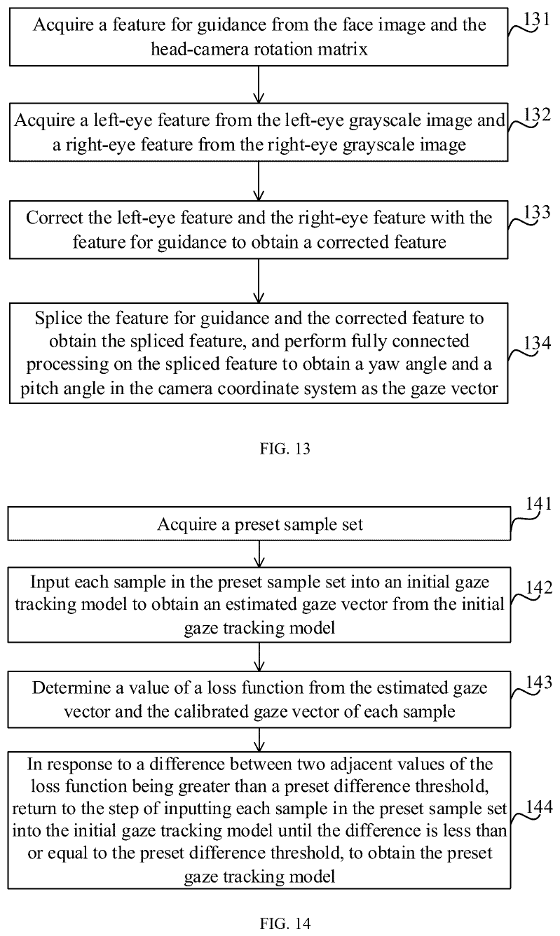

In an example, the processor may acquire the gaze vector of the left eye and the right eye in the camera coordinate system from the left-eye image, the right-eye image, the face image, and the head-camera rotation matrix, which includes steps 131 to 134, as shown in FIG. 13.

At step 131, the processor may acquire a feature for guidance from the face image and the head-camera rotation matrix. For example, the processor may extract a facial feature from the face image. Then, the processor may perform fully connected processing on the head-camera rotation matrix to obtain a head-camera feature. Finally, the processor may splice the facial feature and the head-camera feature to obtain the feature for guidance. It can be understood that the feature for guidance is configured to assist in positioning the eyes.

At step 132, the processor may acquire a left-eye feature from the left-eye grayscale image and a right-eye feature from the right-eye grayscale image. For example, the processor may acquire a preset feature extraction network model, where the feature extraction network model is a ResNet-18 model or a ResNet-50 model, and other backbone network models. Then, the processor may input the left-eye grayscale image and the right-eye grayscale image into the feature extraction network model, respectively, to obtain the left-eye feature from the left-eye grayscale image and the right-eye feature from the right-eye grayscale image. In this step, the grayscale image is used as an input image, which can reduce the processing amount of the feature extraction network model and improve the processing efficiency.

At step 133, the processor may correct the left-eye feature and the right-eye feature with the feature for guidance to obtain a corrected feature.

In this step, the feature for guidance may also be referred to as a vector for guidance. In this step, the processor may correct the left-eye feature and the right-eye feature with the feature for guidance, respectively, to obtain a corrected left-eye feature and a corrected right-eye feature. Since the feature for guidance contains face rotation information, the corrected left-eye feature and the corrected right-eye feature are associated with the face transformation, that is, the corrected left-eye feature and the corrected right-eye feature contain face transformation information, such that the final gaze is associated with pupil transformation and the face rotation.

For example, the processor may acquire a preset AdaGN (Adaptive Group Normalization) module having the feature for guidance as input data. In other words, there is no need to input coordinates of a rectangular box into the AdaGN module, because the left-eye grayscale image, the right-eye grayscale image, and the face image already contain desired targets which do not need to be repositioned, and only the feature for guidance needs to be associated with a rotation angle of each image. The processor may input the feature for guidance into the preset AdaGN module to adjust parameter values of the AdaGN module to obtain a target AdaGN module.

The processor may use the target AdaGN module to perform correction processing on the left-eye feature and the right-eye feature, respectively, to obtain the corrected left-eye feature and the corrected right-eye feature. In this way, the processor uses the feature for guidance to adjust the parameter values of the AdaGN module to make the parameter values more compatible with the facial feature and the head rotation, thereby ensuring that the positions of the left eye and the right eye are compatible with the face position. The number of AdaGN modules may be adjusted from 1 to N for either the left-eye feature or the right-eye feature. Moreover, it is possible to use the AdaGN module to correct features output from a deep network of the feature extraction network model along with features output from a shallow network of the feature extraction network model, and to subsequently merge the deep corrected features with the shallow corrected features, such that information can be obtained from a larger receptive field.

The processor may then splice the corrected left-eye feature and the corrected right-eye feature to obtain the spliced feature. The purpose of the splicing is to unify subsequent processing, which is conducive to improving the processing efficiency.

After that the processor may perform weight adjustment processing on the spliced feature to obtain an adjusted feature. The purpose of the weight adjustment processing is to find, from the corrected left-eye and right-eye features, features of higher interest to be given a larger weight, and features of lower interest to be given a smaller weight.

Finally, the processor may correct the adjusted feature with the feature for guidance to obtain the corrected feature. In this step, correction processing is performed on the left-eye feature and the right-eye feature to highlight features of interest and enable the corrected feature to more accurately reflect the characteristics of the eye gaze.

At step 134, the processor may splice the feature for guidance and the corrected feature to obtain the spliced feature, and perform fully connected processing on the spliced feature to obtain a yaw angle and a pitch angle of the head in the camera coordinate system as the gaze vector. It should be noted that the above gaze vector is acquired in consideration of transformation of the monocular camera to the target camera. In this step, the gaze vector is corrected with the face rotation matrix R, that is, the final gaze vector is obtained from a dot product of an inverse matrix of the face rotation matrix R and the above gaze vector, and for convenience of description, the gaze vector described below refers to the corrected vector. In this step, obtaining the yaw angle and the pitch angle in the camera coordinate system as the gaze vector has the following effects. Firstly, compared with direct output of coordinate data of the gaze point, it is reduced from 3D data to 2D data, which is convenient for training the model. Secondly, it is only related to the original image and not related to the display, which can be applied to scenes provided with a variety of displays, thus facilitating the transplantation and expansion of the scheme and reducing the difficulty of maintenance.

In another example, a preset gaze tracking model is stored in the electronic device. The processor, when acquiring the gaze vector of the left eye and the right eye in the camera coordinate system from the left-eye image, the right-eye image, the face image, and the head-camera rotation matrix, may input the left-eye grayscale image, the right-eye grayscale image, the face image, and the head-camera rotation matrix into the preset gaze tracking model to obtain the gaze vector in the camera coordinate system from the preset gaze tracking model.

In this example, the above preset gaze tracking model is trained in advance. Referring to FIG. 14, the training of the preset gaze tracking model includes steps 141 to 144.

At step 141, the processor may acquire a preset sample set, where the preset sample set includes a pre-collected training sample set, and each sample in the preset sample set includes a calibrated gaze vector.

In this step, sample images in the training sample set may cover as many scenes as possible, including, but not limited to, the average number of men and women, a variety of distributions of face shapes and eye shapes, a variety of eyeglasses, a variety of lighting, wearing masks/no masks. Moreover, images with closed eyes, occluded eyes, and multiple faces appearing on the display are excluded during capture of the images. It should be noted that individual users invited during acquisition of the training sample set are fully aware of the above capture process and the use of the captured images, and affirmatively authorize the subsequent use and dissemination of the sample images.

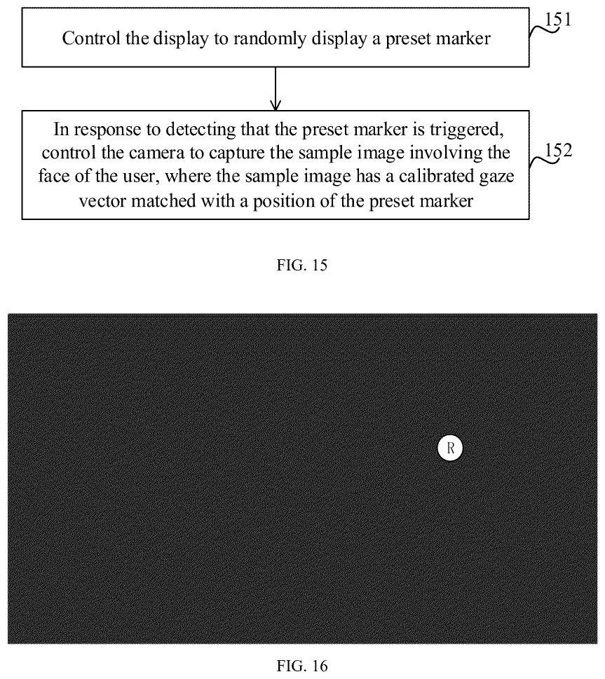

In this step, referring to FIG. 15, the processor may acquire each sample in the training sample set, including steps 151 to 152.

At step 151, the processor may randomly display a preset marker (e.g., a dot) on the display. For example, the processor may divide a display area of the display into n*n sub-display areas, where n is 2˜50. In an example, the display area of the display may be divided into 8*8 sub-display areas. Then, the processor may randomly display the preset marker on the display in each of the sub-display areas, so as to equalize the probability of the preset marker appearing in each sub-display area. In this way, this step can reduce the influence of system errors and improve the quality of the sample image.

At step 152, in response to detecting that the preset marker is triggered, the processor may control the camera to capture the sample image involving the face of the user, where the sample image has a calibrated gaze vector matched with a position of the preset marker.

In this step, for example, the preset marker is a dot, and when the dot is displayed on the display, it may be detected whether the user clicks on the dot. Considering that the user needs to gaze at the dot in order to accurately obtain information on the position of the dot as well as deeper semantic information, the user is gazing at the dot at the instant the user is captured clicking on the dot. In an example, the processor further receives a trigger mode signal for a triggered position. The trigger mode signal includes a first trigger mode and a second trigger mode, for example, clicking a left mouse button is the first trigger mode, and clicking a right mouse button is the second trigger mode. In response to the trigger mode signal being matched with the preset content, the processor may determine that the preset marker is detected to be triggered. The preset content may include a first preset content and a second preset content, for example, the first preset content is a letter “L” and the second preset content is a letter “R”. The first trigger mode is matched with the first preset content, and the second trigger mode is matched with the second preset content.

In order to avoid data noise caused by user distraction, a letter “L” or “R” may appear randomly at the same time when each dot appears, as shown in FIG. 16. When “L” appears, the user needs to click the left mouse button, and when “R” appears, the user needs to click the right mouse button. No data may be recorded in case of clicking error.

In this step, the processor may detect whether the dot is triggered during the display of the dot. When the preset marker is detected to be triggered, the processor may control the camera to capture the sample image involving the face of the user in response to detecting that the preset marker is triggered. Alternatively, the processor may use the image corresponding to the moment when the preset marker is triggered as the sample image during continuous capture of images by the camera.

It can be understood that the position (i.e., pixel coordinate data) of the dot on the display is known. In this case, the gaze vector of the user, i.e., the calibrated gaze vector (the yaw angle and the pitch angle), may be deduced inversely from the coordinate data of the dot, or in other words, the calibrated gaze vector for the sample image is matched with the position of the preset marker.

In order to further avoid data noise caused by user distraction, in an example, each preset marker is displayed for a preset duration (e.g., 3 seconds) at most. In this case, the processor may acquire a display duration that the preset marker is displayed in the sub-display area during the display of the preset marker. In response to the preset marker being triggered or the display duration being equal to a preset duration and the preset marker being not triggered, the processor may control the display to stop displaying the current preset marker and display the next preset marker. For example, each dot is displayed on the display for 3 seconds, and when the display duration reaches 3 seconds, the current dot is no longer displayed and the next dot is displayed on the display, which can prevent the user from gazing elsewhere while moving the mouse to the position of the dot and clicking on the dot, further improving the quality of the sample image.

It should be understood that in this step, a sample image is generated upon the preset marker is triggered. If the user only clicks on the preset marker but the trigger mode is not matched with the preset content, then the image is not saved. In this case, it is considered that the preset marker is not triggered.

In this step, the processor may acquire a number of sample images for a plurality of users as above to obtain the training sample set. In an example, the training sample set includes 8100 sample images of 13 users, and annotation data for each sample image includes ground-truth 2D gaze points and ground-truth 3D gaze vectors, pixel coordinates of four eye corners, pixel coordinates of two mouth corners, head rotation and translation vectors, as well as physical size and pixel size of a screen of a display used by each user, and camera parameters. It should be noted that, in consideration of transformation of the monocular camera to the target camera, the calibrated gaze vector for the sample image in this step is obtained after correction with the face rotation matrix R, that is, the calibrated gaze vector is obtained from a dot product of the face rotation matrix R and the ground-truth gaze vector of the user.

In an example, in order to enrich the number of the sample images, a part of an open source data set, such as MPIIFaceGaze data set, is further added in this step. The MPIIFaceGaze data set is an open source data set, which contains a total of 37767 face images of 15 persons, and annotation data for each face image includes ground-truth 2D gaze points and ground-truth 3D gaze vectors, pixel coordinates of four eye corners, pixel coordinates of two mouth corners, head rotation and translation vectors, as well as physical size and pixel size of a screen of a display used by each person, and camera parameters. In this way, the number of the sample images can be enriched by collecting training samples and open source samples in this embodiment.

At step 142, the processor may input each sample in the preset sample set into an initial gaze tracking model to obtain an estimated gaze vector from the initial gaze tracking model.

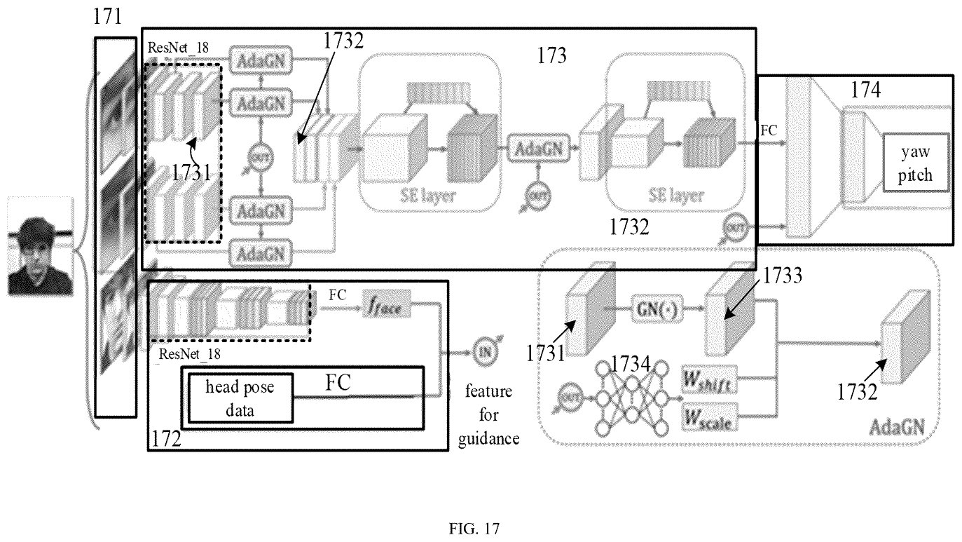

In this step, referring to FIG. 17, a structure of the initial gaze tracking model includes:
an input module 171, a correction module 173, a feature for guidance module 172, and an output module 174.

The input module is configured to input the left-eye grayscale image, the right-eye grayscale image, the face image, and the head-camera rotation matrix.

The feature for guidance module has the face image and the head-camera rotation matrix as input data. For the face image, features are extracted (e.g., by the ResNet-18 model) and then pass through a fully connected layer (FC) to obtain the facial feature f_{face}. The head-camera rotation matrix passes through a fully connected layer (FC) to obtain a head-camera feature. Finally, the facial feature and the head-camera feature are spliced to obtain a feature for guidance.

The correction module has the left-eye grayscale image and the right-eye grayscale image as input data. For the left-eye grayscale image, features are extracted (e.g., by the ResNet-18 model) and then corrected by the AdaGN module to obtain the corrected left-eye feature. For the right-eye grayscale image, features are extracted (e.g., by the ResNet-18 model) and then corrected by the AdaGN module to obtain the corrected right-eye feature. Then, the corrected left-eye feature and the corrected right-eye feature are spliced to obtain the spliced feature, which is subjected to weight adjustment processing by an attention module (SE layer) to obtain the adjusted feature. The adjusted feature is subjected to correction processing by the AdaGN module and weight adjustment processing by another attention module (SE layer) to obtain the corrected feature.

With continued reference to FIG. 17, the AdaGN module includes a network module 1734 and a GN (Group Normalization, a normalization method) module. The network module 1734 may be implemented with 2 to 5 fully connected layers. The feature for guidance may be processed by the network module 1734 to obtain weight coefficients Wshift and Wscale, which respectively represent a shift coefficient and a scaling coefficient of the face. The ResNet-18 model may extract features from the left-eye grayscale image to obtain a left-eye grayscale image feature map 1731, which is subjected to data operation processing by the GN module to obtain a left-eye grayscale image feature map 1733. The left-eye grayscale image feature map 1733 is corrected with the shift coefficient and scaling coefficient to obtain a left-eye grayscale image feature map 1732. It should be noted that when the left-eye grayscale image feature map 1733 is corrected with the weight coefficients Wshift and Wscale, a linear operation may be performed on the left-eye grayscale image feature map 1733 with Wshift and Wscale. It can be seen that the left-eye grayscale image feature map 1732 contains the rotation feature of the left eye and the rotation feature of the face, thereby ensuring that the rotation of the eye is limited by the eye and the face, and improving the accuracy of the left-eye grayscale image feature map 1732. It can be understood that the right-eye grayscale image feature map is acquired in the same manner as the left-eye grayscale image feature map, and will not be repeated herein.

In some examples, the left-eye feature extraction network model in the correction module 173 may include multiple AdaGN modules, which may extract features from different layers of the ResNet-18 model for correction. FIG. 17 illustrates a scenario in which two AdaGN modules are provided, such that the accuracy of the corrected feature can be improved. It can be understood that in the case where the accuracy of the corrected feature can be improved, corresponding solutions fall within the scope of protection of the present disclosure.

The output module splices the corrected feature and the feature for guidance to obtain the spliced feature, and then performs fully connected processing on the spliced feature to obtain the gaze vector (the yaw angle and the pitch angle).

In this step, the processor may input each sample in the preset sample set into an initial gaze tracking model to obtain an estimated gaze vector from the initial gaze tracking model.

At step 143, the processor may determine a value of a loss function from the estimated gaze vector and the calibrated gaze vector of each sample. For example, the processor may acquire a similarity between the estimated gaze vector and the calibrated gaze vector (in the annotation data) of each sample. The similarity may be a cosine angle between two vectors, where a scheme for calculating the similarity may be translated into a mathematical scheme for calculating an angle between two vectors, which will not be described herein. Then, the processor may determine a difference between a constant value 1 and the similarity as the value of the loss function, that is, Loss=1−cos(F1, F2), where F1 is the calibrated gaze vector, and F2 is the estimated gaze vector.

At step 144, in response to a difference between two adjacent values of the loss function being greater than a preset difference threshold, the processor may return to step 142 until the difference is less than or equal to the preset difference threshold, to obtain the preset gaze tracking model, where the preset difference threshold has a value ranging from 0 to 0.2, which may be set according to a specific scene. Alternatively, in response to a difference between two adjacent values of the loss function being greater than a preset difference threshold, the processor may return to step 142 until the difference is less than or equal to the preset difference threshold, to obtain the preset gaze tracking model, where the preset difference threshold has a value ranging from 0 to 0.1, which may be set according to a specific scene.

In this embodiment, training the gaze tracking model with the preset sample set allows the gaze tracking model to converge with better robustness.

In this embodiment, the preset gaze tracking model operates as follows.

(1) A 3*224*224 dimensional face image is input, and is subjected to feature extraction to obtain a 1*64 dimensional facial feature.

(2) A 1*3 dimensional head pose data is input, and is subjected to fully connected processing by a fully connected layer (FC) to obtain a 1*64 dimensional head-camera feature. The head-camera feature is spliced with the above facial feature to obtain a 1*128 dimensional feature for guidance as input data of an AdaGN module.

(3) 1*112*112 left-eye and right-eye grayscale images are input into feature extraction network models, respectively, to obtain image feature maps, where the feature extraction network models corresponding to the left-eye and right-eye grayscale images share weights. The image feature maps are corrected by AdaGN modules, respectively, to obtain a corrected left-eye feature and a corrected right-eye feature. Then, the corrected left-eye feature and the corrected right-eye feature are spliced to obtain the spliced feature.

(4) The spliced feature passes through two attention modules and another AdaGN module to obtain a 1*128 dimensional corrected feature.

(5) The 1*128 dimensional corrected feature, the 1*64 dimensional facial feature and the 1*64 dimensional head-camera feature are spliced, and pass through 3 fully connected layers to obtain a 1*2 dimensional gaze vector.

At step 14, a gaze point of the user on the display is acquired from the gaze vector, physical parameters of the display and an extrinsic matrix of the camera, where the extrinsic matrix of the camera represents a transformation between a display coordinate system and the camera coordinate system.

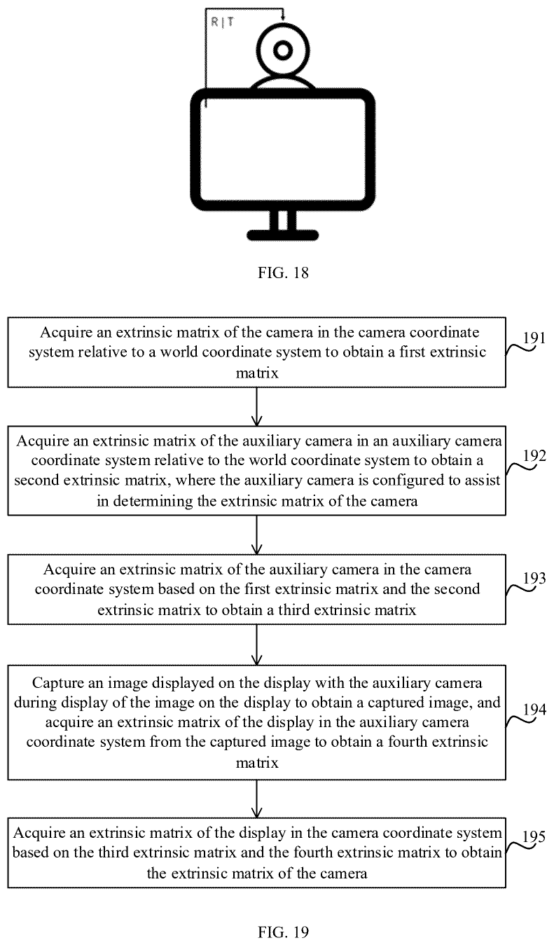

In this step, the extrinsic matrix of the camera is stored in the electronic device. As shown in FIG. 18, the extrinsic matrix (R/T) represents a transformation between a display coordinate system and the camera coordinate system.

In an example, the processor may use an auxiliary camera to determine the extrinsic matrix of the camera, which includes steps 191 to 195, as shown in FIG. 19.

At step 191, the processor may acquire an extrinsic matrix of the camera in the camera coordinate system relative to a world coordinate system to obtain a first extrinsic matrix (R_{A}|t_{A}). The first extrinsic matrix may be configured to make points in the world coordinate system exactly coincide with points in the camera coordinate system after rotation and translation movements. In this step, the first extrinsic matrix may be obtained by using a PNP model.

At step 192, the processor may acquire an extrinsic matrix of the auxiliary camera in an auxiliary camera coordinate system relative to the world coordinate system to obtain a second extrinsic matrix (R_{B}|t_{B}), where the auxiliary camera is configured to assist in determining the extrinsic matrix of the camera.

In this step, referring to FIG. 20, the camera A and the auxiliary camera B are provided in different positions.

The second extrinsic matrix may be configured to make points in the world coordinate system exactly coincide with points in the auxiliary camera coordinate system after rotation and translation movements. In this step, the second extrinsic matrix may be obtained by using a PNP model.

It should be noted that the processor may control the camera and the auxiliary camera to capture images at the same time, or with a delay no more than 30 ms, so as to eliminate the influence of object movements in the world coordinate system and improve the accuracy of acquiring the extrinsic matrix of the camera.

At step 193, the processor may acquire an extrinsic matrix of the auxiliary camera in the camera coordinate system based on the first extrinsic matrix and the second extrinsic matrix to obtain a third extrinsic matrix (R_{X}/t_{X}). Since the camera and the auxiliary camera capture images of the same object, the third extrinsic matrix may be obtained based on coordinate data of the same object.

At step 194, the processor may capture an image displayed on the display with the auxiliary camera during display of the image on the display to obtain a captured image, and acquire an extrinsic matrix of the display in the auxiliary camera coordinate system from the captured image to obtain a fourth extrinsic matrix. In this step, the image captured by the camera is displayed on the display, and the auxiliary camera then captures an image of the display. Based on the same process as above, the extrinsic matrix of the auxiliary camera relative to the display, i.e., the fourth extrinsic matrix (R_{B}′|t_{B}′), may be obtained.

At step 195, the processor may acquire an extrinsic matrix of the display in the camera coordinate system based on the third extrinsic matrix and the fourth extrinsic matrix to obtain the extrinsic matrix of the camera. Since relations between the auxiliary camera and the camera and between the auxiliary camera and the display are determined separately, the relation between the camera and the display may be obtained through an intermediate variable of the auxiliary camera based on the same process as above, that is, the extrinsic matrix (R/T) of the camera may be obtained. Therefore, transformation from a point Y in a display coordinate system to a point X in the camera coordinate system is shown in Equation (1):

$$Y = {R}_{A} {R}_{B}^{- 1} ( ( {R}_{B}^{′} X + {t}_{B}^{′} ) - {t}_{B} ) + {t}_{A} \qquad ( 1 )$$

where Y denotes a point on the display, and X denotes a point in the original image.

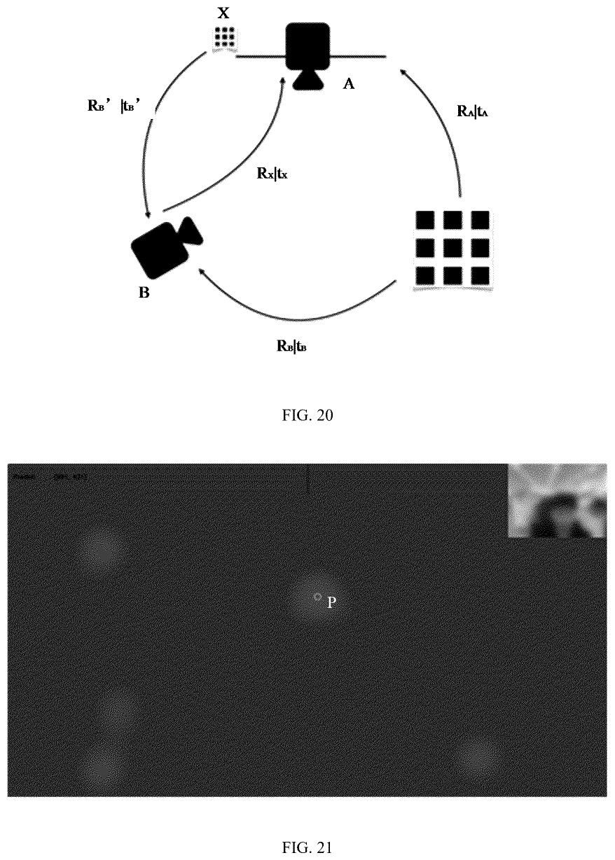

In this step, the processor may acquire a gaze point of the user on the display from the gaze vector, physical parameters of the display and an extrinsic matrix of the camera. For example, the processor may determine coordinate data of the display in the camera coordinate system based on the extrinsic matrix of the camera and the physical parameters (which are known in the annotation data) of the display. Then, the processor may acquire, from the gaze vector and the coordinate data of the display, an intersection point of the gaze vector with the display as the gaze point corresponding to the gaze vector, such as a point P shown in FIG. 21. Calculation of the intersection point of the gaze vector with the display may be translated into calculation of an intersection point of a straight line with a plane in mathematics, and will not be described herein.

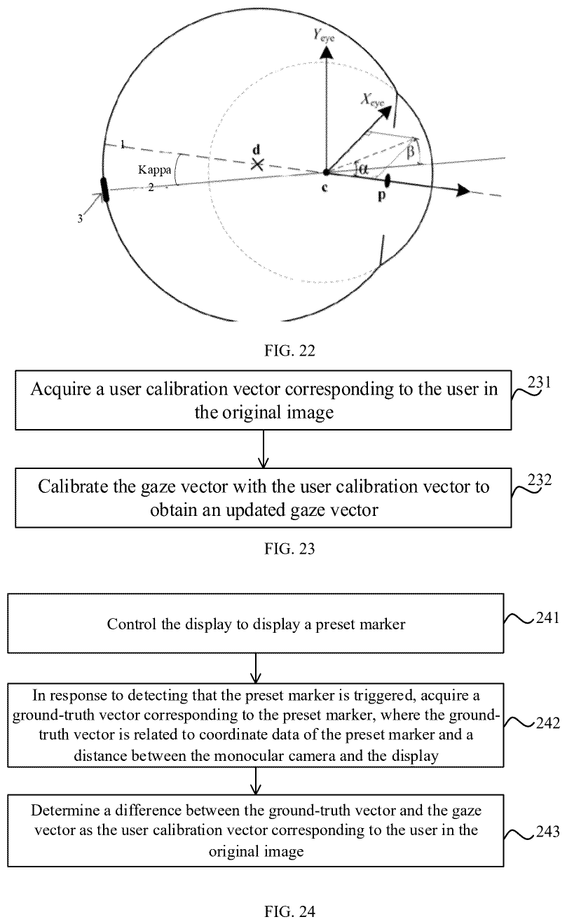

Given differences in internal structure of eyeballs of each user, there may be deviations in the gaze vector determined from the original image. Referring to FIG. 22, the center of pupil of the eye is an optical axis 1 of the eye, which passes through the center of pupil p, the center of curvature of the cornea c, and the center of the eyeball d, and ultimately intersects with the retina at the center of the retina. FIG. 22 illustrates two gazes of the eye, that is, a true gaze 2 indicated by a solid line, and an estimated gaze 1 indicated by a dotted line, and an angle kappa between the two gazes is caused by a fovea 3 of the retina of each user. Therefore, in this step, correction processing is further performed on the determined gaze vector, and includes steps 231 and 232 as shown in FIG. 23.

At step 231, the processor may acquire a user calibration vector corresponding to the user in the original image.

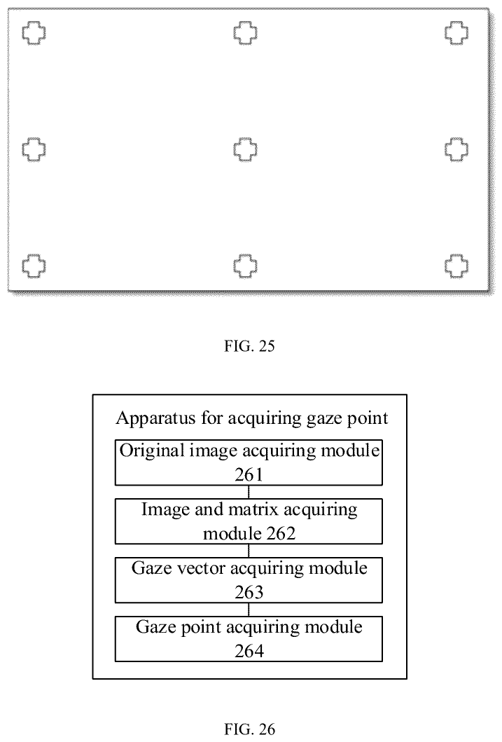

Referring to FIG. 24, at step 241, the processor may display a preset marker on the display. For example, the processor may sequentially display the preset marker at a plurality of designated positions of the display, as shown in FIG. 25. FIG. 25 illustrates a scenario with nine designated positions, at each of which the preset marker (e.g., a cross) is displayed once. When the preset marker is triggered or a display duration of the preset marker is equal to a preset duration, the processor may control the display to stop displaying the preset marker, and display the preset marker at a next designated position randomly selected until the preset marker is displayed once at each of the designate positions.

At step 242, in response to detecting that the preset marker is triggered, the processor may acquire a ground-truth vector corresponding to the preset marker, where the ground-truth vector is related to coordinate data of the preset marker and a distance between the camera and the display. That is, the processor may derive the ground-truth vector from the coordinate position of the preset marker.

At step 243, the processor may determine a difference between the ground-truth vector and the gaze vector (i.e., the angle kappa in FIG. 22) as the user calibration vector corresponding to the user in the original image.

At step 232, the processor may calibrate the gaze vector with the user calibration vector to obtain an updated gaze vector. For example, the processor may acquire a sum of the gaze vector and the user calibration vector, and update the gaze vector to that sum. In this example, a gaze vector matched with each user may be obtained, resulting in a more accurate gaze point.

So far, with the solutions according to the embodiments of the present disclosure, an original image may be acquired from a camera without addition of any expensive image devices, thereby reducing the hardware cost and the complexity of the solutions. A left-eye image, a right-eye image, a face image, and a head-camera rotation matrix are then acquired from the original image, and a gaze vector of a left eye and a right eye in a camera coordinate system is acquired from the left-eye image, the right-eye image, the face image, and the head-camera rotation matrix. Compared with the scheme in which a gaze vector is acquired from an RGB image, use of a left-eye grayscale image and a right-eye grayscale image can reduce the amount of data processing and improve the processing speed. Finally, a gaze point of the user on a display is acquired from the gaze vector, physical parameters of the display, and an extrinsic matrix of the camera. Compared with direct output of a gaze point, acquiring the gaze point after the gaze vector can be applied to different displays, which expands applicable scenes of the present disclosure.

On the basis of the method of acquiring a gaze point according to an embodiment of the present disclosure, an embodiment of the present disclosure further provides an apparatus for acquiring a gaze point. Referring to FIG. 26, the apparatus includes:
an original image acquiring module 261, configured to acquire an original image of a user from a camera;
an image and matrix acquiring module 262, configured to acquire a left-eye image of a left eye of the user, a right-eye image of a right eye of the user, a face image of a face of the user, and a head-camera rotation matrix from the original image, where the head-camera rotation matrix represents a rotation of a head of the user relative to the camera;
a gaze vector acquiring module 263, configured to acquire a gaze vector of the left eye and the right eye in a camera coordinate system from the left-eye image, the right-eye image, the face image, and the head-camera rotation matrix; and
a gaze point acquiring module 264, configured to acquire a gaze point of the user on a display from the gaze vector, physical parameters of the display and an extrinsic matrix of the camera, where the extrinsic matrix of the camera represents a transformation between a display coordinate system and the camera coordinate system.

Optionally, the image and matrix acquiring module includes:
an intrinsic matrix acquiring submodule, configured to acquire an intrinsic matrix of the camera;
a head pose acquiring submodule, configured to acquire head pose data from the original image; and
an image acquiring submodule, configured to acquire the left-eye image, the right-eye image, and the face image, respectively, from the original image, the intrinsic matrix, and the head pose data, where the left-eye image is a front-view image centered at a center of the left eye, the right-eye image is a front-view image centered at a center of the right eye, and the face image is a front-view image centered at a center of the face.

Optionally, the image and matrix acquiring module further includes:
a grayscale image acquiring submodule, configured to obtain a left-eye grayscale image and a right-eye grayscale image from the left-eye image and the right-eye image, respectively.

Optionally, the head pose acquiring submodule includes:
a keypoint acquiring unit, configured to input the original image into a preset keypoint detection model to obtain 2D keypoint coordinates in the camera coordinate system; and
a head pose acquiring unit, configured to input preset 3D keypoint coordinates in a head coordinate system and the 2D keypoint coordinates into a preset perspective projection model, to acquire, from the preset perspective projection model, a rotation matrix and a displacement matrix of the head relative to the camera as the head pose data.

Optionally, the preset keypoint detection model is configured to detect a preset number of keypoints of the face of the user from the original image, where the preset number is more than 106.

Optionally, the image acquiring submodule includes:
a face matrix acquiring unit, configured to acquire, from the head pose data, a face transformation matrix;
a left-eye matrix acquiring unit, configured to acquire, from the head pose data, a left-eye transformation matrix;
a right-eye matrix acquiring unit, configured to acquire, from the head pose data, a right-eye transformation matrix;
a left-eye image acquiring unit, configured to acquire the left-eye image from the original image and the left-eye transformation matrix;
a right-eye image acquiring unit, configured to acquire the right-eye image from the original image and the right-eye transformation matrix; and
a face image acquiring unit, configured to acquire the face image from the original image and the face transformation matrix.

Optionally, the face matrix acquiring unit includes:
a Z-axis acquiring subunit, configured to adjust an origin of a Z-axis of the camera coordinate system to be an origin of the head coordinate system such that the camera directly faces a center point of the face;
a Y-axis adjusting subunit, configured to adjust an X-axis of the camera coordinate system to be parallel to an X-axis of the head coordinate system such that the head remains horizontal in the camera coordinate system to obtain a Y-axis of the camera coordinate system;
an X-axis adjusting subunit, configured to acquire the X-axis of the camera coordinate system from the Z-axis and the Y-axis of the camera coordinate system to obtain a face rotation matrix;
an initial matrix acquiring subunit, configured to obtain an initial face transformation matrix from the face rotation matrix and a preset scaling matrix; and
a face matrix acquiring subunit, configured to acquire, from the intrinsic matrix, a target camera matrix and the initial face transformation matrix, the face transformation matrix of the target camera matrix with respect to an original camera matrix.

Optionally, the left-eye matrix acquiring unit includes:
a Z-axis acquiring subunit, configured to adjust an origin of a Z-axis of the camera coordinate system to be an origin of a left-eye coordinate system such that the camera directly faces a center point of the left eye;
a Y-axis adjusting subunit, configured to adjust an X-axis of the camera coordinate system to be parallel to an X-axis of the left-eye coordinate system such that the left eye remains horizontal in the camera coordinate system to obtain a Y-axis of the camera coordinate system;
an X-axis adjusting subunit, configured to acquire the X-axis of the camera coordinate system from the Z-axis and the Y-axis of the camera coordinate system to obtain a left-eye rotation matrix;
an initial matrix acquiring subunit, configured to obtain an initial left-eye transformation matrix from the left-eye rotation matrix and a preset scaling matrix; and
a left-eye matrix acquiring subunit, configured to acquire, from the intrinsic matrix, a target camera matrix and the initial left-eye transformation matrix, the left-eye transformation matrix of the target camera matrix with respect to an original camera matrix.

Optionally, the right-eye matrix acquiring unit includes:
a Z-axis acquiring subunit, configured to adjust an origin of a Z-axis of the camera coordinate system to be an origin of a right-eye coordinate system such that the camera directly faces a center point of the right eye;
a Y-axis adjusting subunit, configured to adjust an X-axis of the camera coordinate system to be parallel to an X-axis of the right-eye coordinate system such that the right eye remains horizontal in the camera coordinate system to obtain a Y-axis of the camera coordinate system;
an X-axis adjusting subunit, configured to acquire the X-axis of the camera coordinate system from the Z-axis and the Y-axis of the camera coordinate system to obtain a right-eye rotation matrix;
an initial matrix acquiring subunit, configured to obtain an initial right-eye transformation matrix from the right-eye rotation matrix and a preset scaling matrix; and
a right-eye matrix acquiring subunit, configured to acquire, from the intrinsic matrix, a target camera matrix and the initial right-eye transformation matrix, the right-eye transformation matrix of the target camera matrix with respect to an original camera matrix.

Optionally, the gaze vector acquiring module includes:
a feature for guidance acquiring submodule, configured to acquire a feature for guidance from the face image and the head-camera rotation matrix;
a left-eye feature acquiring submodule, configured to acquire a left-eye feature from the left-eye grayscale image;
a right-eye feature acquiring submodule, configured to acquire a right-eye feature from the right-eye grayscale image;
a corrected feature acquiring submodule, configured to correct the left-eye feature and the right-eye feature with the feature for guidance to obtain a corrected feature; and
a gaze vector acquiring submodule, configured to splice the feature for guidance and the corrected feature and perform fully connected processing on the spliced feature to obtain a yaw angle and a pitch angle of the head in the camera coordinate system as the gaze vector.

Optionally, the feature for guidance acquiring submodule includes:
a facial feature extracting unit, configured to extract a facial feature from the face image;
a head-camera feature acquiring unit, configured to perform fully connected processing on the head-camera rotation matrix to obtain a head-camera feature; and
a feature for guidance acquiring unit, configured to splice the facial feature and the head-camera feature to obtain the feature for guidance.

Optionally, the left-eye feature acquiring submodule includes:
a network model acquiring unit, configured to acquire a preset feature extraction network model, where the feature extraction network model is a ResNet-18 model; and
a left-eye feature acquiring unit, configured to input the left-eye grayscale image into the feature extraction network model to obtain the left-eye feature from the left-eye grayscale image; and
the right-eye feature acquiring submodule includes:
a network model acquiring unit, configured to acquire a preset feature extraction network model, where the feature extraction network model is a ResNet-18 model; and
a right-eye feature acquiring unit, configured to input the right-eye grayscale image into the feature extraction network model to obtain the right-eye feature from the right-eye grayscale image.

Optionally, the corrected feature acquiring submodule includes:
an corrected eye feature acquiring unit, configured to correct the left-eye feature and the right-eye feature with the feature for guidance to obtain a corrected left-eye feature and a corrected right-eye feature, respectively;
a spliced feature acquiring unit, configured to splice the corrected left-eye feature and the corrected right-eye feature to obtain the spliced feature;
an adjusted feature acquiring unit, configured to perform weight adjustment processing on the spliced feature to obtain an adjusted feature; and
a corrected feature acquiring unit, configured to correct the adjusted feature with the feature for guidance to obtain the corrected feature.

Optionally, the corrected eye feature acquiring unit includes:
a preset model acquiring subunit, configured to acquire a preset AdaGN module having the feature for guidance as input data;
a target model acquiring subunit, configured to input the feature for guidance into the preset AdaGN module to adjust a parameter value of the AdaGN module and obtain a target AdaGN module; and
an eye feature correcting subunit, configured to correct the left-eye feature and the right-eye feature with the target AdaGN module to obtain the corrected left-eye feature and the corrected right-eye feature, respectively.

Optionally, the gaze vector acquiring module includes:
a gaze vector acquiring submodule, configured to input the left-eye grayscale image, the right-eye grayscale image, the face image, and the head-camera rotation matrix into a preset gaze tracking model to obtain the gaze vector in the camera coordinate system from the preset gaze tracking model.

Optionally, the apparatus further includes a tracking model training module configured to train the preset gaze tracking model. The tracking model training module includes:
a sample set acquiring submodule, configured to acquire a preset sample set, where the preset sample set includes a pre-collected training sample set, and each sample in the preset sample set includes a calibrated gaze vector;
an estimated vector acquiring submodule, configured to input each sample in the preset sample set into an initial gaze tracking model to obtain an estimated gaze vector from the initial gaze tracking model;
a function value determining submodule, configured to determine a value of a loss function from the estimated gaze vector and the calibrated gaze vector of each sample; and
a tracking model acquiring submodule, configured to in response to a difference between two adjacent values of the loss function being greater than a preset difference threshold, return to the operation of inputting each sample in the preset sample set into the initial gaze tracking model until the difference is less than or equal to the preset difference threshold, to obtain the preset gaze tracking model.

Optionally, the function value determining submodule includes:
a similarity acquiring unit, configured to acquire a similarity between the estimated gaze vector and the calibrated gaze vector of each sample; and
a value determining unit, configured to determine a difference between a constant value and the similarity as the value of the loss function.

Optionally, the sample set acquiring submodule includes:
a preset marker display unit, configured to randomly display a preset marker on the display; and
a sample image capturing unit, configured to in response to detecting that the preset marker is triggered, control the camera to capture a sample image involving the face of the user, where the sample image has a calibrated gaze vector matched with a position of the preset marker.

Optionally, the preset marker display unit includes:
a display area dividing subunit, configured to divide a display area of the display into n*n sub-display areas; and
a preset marker display subunit, configured to randomly display the preset marker on the display in each of the sub-display areas.

Optionally, the preset marker display subunit includes:
a display duration acquiring sub-subunit, configured to acquire a display duration that the preset marker is displayed in the sub-display area during display of the preset marker; and
a preset marker display sub-subunit, configured to in response to the preset marker being triggered or the display duration being equal to a preset duration and the preset marker being not triggered, stop displaying a current preset marker and display a next preset marker.

Optionally, the preset marker contains a preset content, and the sample image capturing unit includes:
a trigger mode acquiring subunit, configured to receive a trigger mode signal for a triggered position; and
a marker trigger subunit, configured to in response to the trigger mode signal being matched with the preset content, determine that the preset marker is detected to be triggered.

Optionally, the preset content includes a first preset content and a second preset content, the trigger mode signal includes a first trigger mode and a second trigger mode, the first trigger mode is matched with the first preset content, and the second trigger mode is matched with the second preset content. Optionally, the apparatus further includes:
a calibration vector acquiring module, configured to acquire a user calibration vector corresponding to the user in the original image; and
a gaze vector update module, configured to calibrate the gaze vector with the user calibration vector to obtain an updated gaze vector.

Optionally, the calibration vector acquiring module includes:
a preset marker display submodule, configured to display a preset marker on the display;
a ground-truth vector acquiring submodule, configured to in response to detecting that the preset marker is triggered, acquiring a ground-truth vector corresponding to the preset marker, where the ground-truth vector is related to coordinate data of the preset marker and a distance between the camera and the display; and
a calibration vector determining submodule, configured to determine a difference between the ground-truth vector and the gaze vector as the user calibration vector.

Optionally, the preset marker display submodule includes:
a preset marker display unit, configured to sequentially display the preset marker at a plurality of designated positions of the display; and
a display stopping unit, configured to stop displaying the preset marker in response to the preset marker being triggered or a display duration of the preset marker being equal to a preset duration; and
the preset marker display unit is further configured to display the preset marker at a next designated position randomly selected until the preset marker is displayed once at each of the designate positions.

Optionally, the gaze point acquiring module includes:
a coordinate data determining submodule, configured to determine coordinate data of the display in the camera coordinate system based on the extrinsic matrix of the camera and the physical parameters of the display; and
a gaze point acquiring submodule, configured to acquire, from the gaze vector, coordinates of a center point of the face, and the coordinate data, an intersection point of the gaze vector with the display as the gaze point.

Optionally, the coordinate data determining submodule includes:
an extrinsic matrix acquiring unit, configured to use an auxiliary camera to determine the extrinsic matrix of the camera.

Optionally, the extrinsic matrix acquiring unit includes:
a first extrinsic matrix acquiring subunit, configured to acquire an extrinsic matrix of the camera in the camera coordinate system relative to a world coordinate system to obtain a first extrinsic matrix;
a second extrinsic matrix acquiring subunit, configured to acquire an extrinsic matrix of the auxiliary camera in an auxiliary camera coordinate system relative to the world coordinate system to obtain a second extrinsic matrix, where the auxiliary camera is configured to assist in determining the extrinsic matrix of the camera;
a third extrinsic matrix acquiring subunit, configured to acquire an extrinsic matrix of the auxiliary camera in the camera coordinate system based on the first extrinsic matrix and the second extrinsic matrix to obtain a third extrinsic matrix;
a fourth extrinsic matrix acquiring subunit, configured to capture an image displayed on the display with the auxiliary camera during display of the image on the display to obtain a captured image, and acquire an extrinsic matrix of the display in the auxiliary camera coordinate system from the captured image to obtain a fourth extrinsic matrix; and an extrinsic matrix acquiring subunit, configured to acquire an extrinsic matrix of the display in the camera coordinate system based on the third extrinsic matrix and the fourth extrinsic matrix to obtain the extrinsic matrix of the camera.

According to an embodiment of the present disclosure, there is further provided an apparatus for acquiring a training sample set, including:
a preset marker control module, configured to randomly display a preset marker on a display; and
a sample image acquiring module, configured to in response to detecting that the preset marker is triggered, control a camera to capture a sample image involving a face of a user, where the sample image has a calibrated gaze vector matched with a position of the preset marker.

It should be noted that the apparatus illustrated in this embodiment is matched with the above method embodiment to which reference may be made, and will not be repeated herein.

In an exemplary embodiment, there is further provided an electronic device, including:
a camera;
a display;
a processor; and
a non-transitory memory for storing a computer program executable by the processor,
where the processor is configured to execute the computer program in the memory to implement the methods as described above.

In an exemplary embodiment, there is further provided a non-transitory computer-readable storage medium, for example, a memory including an executable computer program, which is executable by a processor to implement the methods according to the above embodiments. The readable storage medium may include ROM, random access memory (RAM), CD-ROM, magnetic tape, floppy disk, optical data storage device, etc.

Other embodiments of the present disclosure will occur to those skilled in the art upon consideration of the specification and practice of the disclosure set forth herein. The present disclosure is intended to cover any variations, uses, or adaptations that follow the general principles of the present disclosure and include common general knowledge or commonly used technical means in the art not disclosed in the present disclosure. The specification and embodiments are considered as exemplary only, with a true scope and spirit of the present disclosure being indicated by the following claims.

1. A method of acquiring a gaze point, comprising:
acquiring an original image of a user from a camera;
acquiring, from the original image, a left-eye image of a left eye of the user, a right-eye image of a right eye of the user, a face image of a face of the user, and a head-camera rotation matrix, wherein the head-camera rotation matrix represents a rotation of a head of the user relative to the camera;
acquiring, from the left-eye image, the right-eye image, the face image, and the head-camera rotation matrix, a gaze vector of the left eye and the right eye in a camera coordinate system; and
acquiring, from the gaze vector, physical parameters of a display and an extrinsic matrix of the camera, a gaze point of the user on the display, wherein the extrinsic matrix of the camera represents a transformation between a display coordinate system and the camera coordinate system.

2. The method according to claim 1, wherein acquiring, from the original image, the left-eye image, the right-eye image, the face image, and the head-camera rotation matrix, comprises:
acquiring an intrinsic matrix of the camera and acquiring head pose data from the original image; and
acquiring, from the original image, the intrinsic matrix, and the head pose data, the left-eye image, the right-eye image, and the face image, respectively,
wherein the left-eye image is a front-view image centered at a center of the left eye, the right-eye image is a front-view image centered at a center of the right eye, and the face image is a front-view image centered at a center of the face.

3. The method according to claim 2, further comprising:
obtaining a left-eye grayscale image and a right-eye grayscale image from the left-eye image and the right-eye image, respectively.

4. The method according to claim 2, wherein acquiring the head pose data, comprises:
inputting the original image into a preset keypoint detection model to obtain 2D keypoint coordinates in the camera coordinate system; and
inputting preset 3D keypoint coordinates in a head coordinate system and the 2D keypoint coordinates into a preset perspective projection model, to acquire, from the preset perspective projection model, a rotation matrix and a displacement matrix of the head relative to the camera as the head pose data.

5. (canceled)

6. The method according to claim 2, wherein acquiring, from the original image, the intrinsic matrix, and the head pose data, the left-eye image, the right-eye image, and the face image, respectively, comprises:
acquiring, from the head pose data, a face transformation matrix, a left-eye transformation matrix, and a right-eye transformation matrix; and
acquiring the left-eye image from the original image and the left-eye transformation matrix, acquiring the right-eye image from the original image and the right-eye transformation matrix, and acquiring the face image from the original image and the face transformation matrix.

7. The method according to claim 6, wherein acquiring, from the head pose data, the face transformation matrix, comprises:
adjusting an origin of a Z-axis of the camera coordinate system to be an origin of a head coordinate system such that the camera directly faces a center point of the face;
adjusting an X-axis of the camera coordinate system to be parallel to an X-axis of the head coordinate system such that the head remains horizontal in the camera coordinate system to obtain a Y-axis of the camera coordinate system;
acquiring the X-axis of the camera coordinate system from the Z-axis and the Y-axis of the camera coordinate system to obtain a face rotation matrix;
obtaining an initial face transformation matrix from the face rotation matrix and a preset scaling matrix; and
acquiring, from the intrinsic matrix, a target camera matrix and the initial face transformation matrix, the face transformation matrix of the target camera matrix with respect to an original camera matrix.

8. The method according to claim 6, wherein acquiring, from the head pose data, the left-eye transformation matrix, comprises:
adjusting an origin of a Z-axis of the camera coordinate system to be an origin of a left-eye coordinate system such that the camera directly faces a center point of the left eye;
adjusting an X-axis of the camera coordinate system to be parallel to an X-axis of the left-eye coordinate system such that the left eye remains horizontal in the camera coordinate system to obtain a Y-axis of the camera coordinate system;
acquiring the X-axis of the camera coordinate system from the Z-axis and the Y-axis of the camera coordinate system to obtain a left-eye rotation matrix;
obtaining an initial left-eye transformation matrix from the left-eye rotation matrix and a preset scaling matrix; and
acquiring, from the intrinsic matrix, a target camera matrix and the initial left-eye transformation matrix, the left-eye transformation matrix of the target camera matrix with respect to an original camera matrix.

9. The method according to claim 6, wherein acquiring, from the head pose data, the right-eye transformation matrix, comprises:
adjusting an origin of a Z-axis of the camera coordinate system to be an origin of a right-eye coordinate system such that the camera directly faces a center point of the right eye;
adjusting an X-axis of the camera coordinate system to be parallel to an X-axis of the right-eye coordinate system such that the right eye remains horizontal in the camera coordinate system to obtain a Y-axis of the camera coordinate system;
acquiring the X-axis of the camera coordinate system from the Z-axis and the Y-axis of the camera coordinate system to obtain a right-eye rotation matrix;
obtaining an initial right-eye transformation matrix from the right-eye rotation matrix and a preset scaling matrix; and
acquiring, from the intrinsic matrix, a target camera matrix and the initial right-eye transformation matrix, the right-eye transformation matrix of the target camera matrix with respect to an original camera matrix.

10. The method according to claim 43, wherein acquiring, from the left-eye image, the right-eye image, the face image, and the head-camera rotation matrix, the gaze vector of the left eye and the right eye in the camera coordinate system, comprises:
acquiring a feature for guidance from the face image and the head-camera rotation matrix;
acquiring a left-eye feature from the left-eye grayscale image and a right-eye feature from the right-eye grayscale image;
correcting the left-eye feature and the right-eye feature with the feature for guidance to obtain a corrected feature; and
splicing the feature for guidance and the corrected feature to obtain the spliced feature, and performing fully connected processing on the spliced feature to obtain a yaw angle and a pitch angle of the head in the camera coordinate system as the gaze vector.

11. The method according to claim 10, wherein acquiring the feature for guidance from the face image and the head-camera rotation matrix, comprises:
extracting a facial feature from the face image;
performing fully connected processing on the head-camera rotation matrix to obtain a head-camera feature; and
splicing the facial feature and the head-camera feature to obtain the feature for guidance.

12. (canceled)

13. The method according to claim 10, wherein correcting the left-eye feature and the right-eye feature with the feature for guidance to obtain the corrected feature, comprises:
correcting the left-eye feature and the right-eye feature with the feature for guidance to obtain a corrected left-eye feature and a corrected right-eye feature, respectively;
splicing the corrected left-eye feature and the corrected right-eye feature to obtain the spliced feature;
performing weight adjustment processing on the spliced feature to obtain an adjusted feature; and
correcting the adjusted feature with the feature for guidance to obtain the corrected feature.

14. (canceled)

15. The method according to claim 13, wherein acquiring, from the left-eye image, the right-eye image, the face image, and the head-camera rotation matrix, the gaze vector of the left eye and the right eye in the camera coordinate system, comprises:
inputting the left-eye grayscale image, the right-eye grayscale image, the face image, and the head-camera rotation matrix into a preset gaze tracking model to obtain the gaze vector in the camera coordinate system from the preset gaze tracking model,
wherein the preset gaze tracking model is trained by operations comprising:
acquiring a preset sample set, wherein the preset sample set comprises a pre-collected training sample set, and each sample in the preset sample set comprises a calibrated gaze vector;
inputting each sample in the preset sample set into an initial gaze tracking model to obtain an estimated gaze vector from the initial gaze tracking model;
determining a value of a loss function from the estimated gaze vector and the calibrated gaze vector of each sample; and
in response to a difference between two adjacent values of the loss function being greater than a preset difference threshold, returning to the operation of inputting each sample in the preset sample set into the initial gaze tracking model until the difference is less than or equal to the preset difference threshold, to obtain the preset gaze tracking model.

16-17. (canceled)

18. The method according to claim 15, wherein each sample in the preset sample set is acquired by:
randomly displaying a preset marker on the display; and
in response to detecting that the preset marker is triggered, controlling the camera to capture a sample image involving the face of the user, wherein the sample image has a calibrated gaze vector matched with a position of the preset marker.

19. The method according to claim 18, wherein randomly displaying the preset marker on the display, comprises:
dividing a display area of the display into n*n sub-display areas; and
randomly displaying the preset marker on the display in each of the sub-display areas,
wherein randomly displaying the preset marker on the display in each of the sub-display areas, comprises:
acquiring a display duration that the preset marker is displayed in the sub-display area during display of the preset marker; and
in response to the preset marker being triggered or the display duration being equal to a preset duration and the preset marker being not triggered, stopping displaying a current preset marker and displaying a next preset marker.

20. (canceled)

21. The method according to claim 19, wherein the preset marker contains a preset content, and detecting that the preset marker is triggered, comprises:
receiving a trigger mode signal for a triggered position; and
in response to the trigger mode signal being matched with the preset content, determining that the preset marker is detected to be triggered,
wherein the preset content comprises a first preset content and a second preset content, the trigger mode signal comprises a first trigger mode and a second trigger mode, the first trigger mode is matched with the first preset content, and the second trigger mode is matched with the second preset content.

22. (canceled)

23. The method according to claim 1, further comprising:
acquiring a user calibration vector corresponding to the user in the original image; and
calibrating the gaze vector with the user calibration vector to obtain an updated gaze vector.

24. The method according to claim 23, wherein acquiring the user calibration vector corresponding to the user in the original image, comprises:
displaying a preset marker on the display;
in response to detecting that the preset marker is triggered, acquiring a ground-truth vector corresponding to the preset marker, wherein the ground-truth vector is related to coordinate data of the preset marker and a distance between the camera and the display; and
determining a difference between the ground-truth vector and the gaze vector as the user calibration vector,
wherein displaying the preset marker on the display, comprises:
sequentially displaying the preset marker at a plurality of designated positions of the display;
stopping displaying the preset marker in response to the preset marker being triggered or a display duration of the preset marker being equal to a preset duration; and
displaying the preset marker at a next designated position randomly selected until the preset marker is displayed once at each of the designate positions.

25. (canceled)

26. The method according to claim 1, wherein acquiring, from the gaze vector, the physical parameters of the display and the extrinsic matrix of the camera, the gaze point of the user on the display, comprises:
determining coordinate data of the display in the camera coordinate system based on the extrinsic matrix of the camera and the physical parameters of the display; and
acquiring, from the gaze vector, coordinates of a center point of the face, and the coordinate data, an intersection point of the gaze vector with the display as the gaze point.

27. The method according to claim 1, wherein acquiring the extrinsic matrix of the camera is by:
acquiring a first extrinsic matrix of the camera in the camera coordinate system relative to a world coordinate system;
acquiring a second extrinsic matrix of an auxiliary camera in an auxiliary camera coordinate system relative to the world coordinate system, wherein the auxiliary camera is configured to assist in determining the extrinsic matrix of the camera;
acquiring a third extrinsic matrix of the auxiliary camera in the camera coordinate system based on the first extrinsic matrix and the second extrinsic matrix;
capturing an image displayed on the display with the auxiliary camera during display of the image on the display to obtain a captured image, and acquiring a fourth extrinsic matrix of the display in the auxiliary camera coordinate system from the captured image; and
acquiring an extrinsic matrix of the display in the camera coordinate system based on the third extrinsic matrix and the fourth extrinsic matrix to obtain the extrinsic matrix of the camera.

28-35. (canceled)

36. An electronic device, comprising:
a camera;
a display;
a processor; and
a non-transitory memory for storing a computer program executable by the processor,
wherein the processor is configured to execute the computer program in the memory to implement the method according to claim 1.

37. A non-transitory computer-readable storage medium, wherein when an executable computer program in the storage medium is executed by a processor, the method according to claim 1 is implemented.
